(19) United States
(12) Patent Application Publication
(10) Pub. No.: US 2026/0230185 A1
(43) Pub. Date: Aug. 6, 2026

(54) INTENSITY MODULATED DIRECT DETECTION (IMDD) OPTICAL TRANSCEIVER SYSTEM

(71) Applicant: Dell Products L.P., Round Rock, TX (US)

(72) Inventor: David Piehler, Mountain View, CA (US)

(21) Appl. No.: 19/051,261

(22) Filed: Feb. 12, 2025

Related U.S. Application Data
(60) Provisional application No. 63/752,923, filed on Feb. 3, 2025.

(51) Int. Cl. H04B 10/40; H04B 10/50; H04B 10/54; H04B 10/66

(52) U.S. Cl. CPC H04B 10/40; H04B 10/503; H04B 10/54; H04B 10/66

(57) ABSTRACT

An IMDD optical transceiver system includes first and second transceiver devices connected to an optical cable. The first transceiver device modulates light to generate first and second optical signals having the same data and respective 180-degree out-of-phase intensities, rotates a polarization of the second optical signal to provide an orthogonally polarized second optical signal, and combines the first and orthogonally polarized second optical signal while maintaining their relative polarization orthogonality to provide a combined optical signal that it transmits via the optical cable. The first optical receiver receives the combined optical signal via the optical cable, separates the first and orthogonally polarized second optical signal in the first combined optical signal, converts the first and orthogonally polarized second optical signal to first and second electrical signals, respectively, and combines them to provide a combined electrical signal, and transmits the combined electrical signal.

### CROSS-REFERENCE TO RELATED APPLICATION

This application claims the benefit of U.S. Provisional Patent Application Ser. No. 63/752,923, filed Feb. 3, 2025, which is incorporated by reference herein in its entirety.

### BACKGROUND

The present disclosure relates generally to information handling systems, and more particularly to Intensity Modulated Direct Detection (IMDD) optical transceiver systems used with information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, artificial intelligence/machine learning training/inference, or global communications. In addition, information handling systems may include a variety of hardware and software components that may be configured to process, store, and communicate information and may include one or more computer systems, data storage systems, and networking systems.

Information handling systems such as, for example, server devices, networking devices (e.g., switch devices), storage systems, artificial intelligence fabrics and/or other computing systems known in the art are sometimes coupled together using a transceiver system (e.g., transceiver devices, optical cables and/or other optical fiber transmission mediums, and/or other transceiver system components know in the art) in order to enable the exchange of data. The transceiver devices in such transceiver systems include optical transmitters that convert data stream(s) encoded in distinct electrical signal(s) into lightwaves that are used to provide modulated optical signal(s) encoded with the data stream(s), and transmit those optical signal(s) via optical fiber cables. Transceiver devices in such transceiver systems also include optical receivers that convert data stream(s) encoded in distinct optical signal(s) received via optical fiber cables into distinct electrical signal(s) encoded with the data stream(s).

For example, “Intensity Modulated Direct Detection” (IMDD) optical transceiver devices are often utilized with computing devices in datacenters, artificial intelligence/machine learning systems, and telecommunications systems, and provide a simple, cost-effective option relative to coherent detection optical transceiver devices. As will be appreciated by one of skill in the art in possession of the present disclosure, IMDD optical transceiver devices are generally provided by relatively lower complexity optical transmit and receive devices that are often used within datacenters and Artificial Intelligence (AI) scale-up, scale-out and backend fabrics, and may be distinguished from the relatively more complex coherent detection optical transceiver devices discussed above that are often used in long-haul telecommunications, and that encode signals with optical amplitude and phase modulation, and detect signals via heterodyne mixing using a local laser oscillator.

However, as discussed in detail below, the inventor of the present disclosure has recognized that signal-dependent noise (e.g., the shot noise and/or Relative Intensity Noise (RIN) discussed below) can result in relatively significant impacts on conventional IMDD optical transceiver devices that require the use of relatively higher cost, higher quality, lower noise light sources, and/or that make the use of noise-increasing optical amplifiers difficult, and has developed the IMDD optical transceiver systems described in detail herein that improve the quality of optical signals relative to those transmitted by conventional IMDD optical transceiver devices for any particular combination of data rate, modulation format, symbol rate, extinction ratio, light source with any RIN, and optical power.

### SUMMARY

According to one embodiment, an Intensity Modulated Direct Detection (IMDD) transceiver device includes an optical transmitter including: an Electro-Optical Modulator (EOM) that includes an optical directional coupler and that is configured to modulate light to generate a first optical signal and a second optical signal that include the same data and that include respective intensities that are 180 degrees out of phase; a polarization rotator that is coupled to the EOM and that is configured to receive the second optical signal and rotate a polarization of the second optical signal to provide an orthogonally polarized second optical signal that is orthogonally polarized relative to the first optical signal; and a polarization beam splitter that is coupled to the EOM and the polarization rotator and that is configured to receive the first optical signal and the orthogonally polarized second optical signal, combine the first optical signal and the orthogonally polarized second optical signal while maintaining a polarization orthogonality of the first optical signal and the orthogonally polarized second optical signal to provide a first combined optical signal, and transmit the first combined optical signal via an optical cable.

### BRIEF DESCRIPTION OF THE DRAWINGS

FIG. 1 is a schematic view illustrating an embodiment of an Information Handling System (IHS).

FIG. 2A is a schematic view illustrating an embodiment of a networked system that may include the IMDD optical transceiver system of the present disclosure.

FIG. 2B is a schematic view illustrating an embodiment of the networked system of FIG. 2A providing the IMDD optical transceiver system of the present disclosure.

FIG. 2C is a schematic view illustrating an embodiment of the networked system of FIG. 2A providing the IMDD optical transceiver system of the present disclosure.

FIG. 3 is a schematic view illustrating an embodiment of a conventional externally-modulated IMDD optical transmitter.

FIG. 4 is a schematic view illustrating an embodiment of a conventional IMDD optical receiver.

FIG. 5A is a schematic view illustrating an embodiment of the conventional externally-modulated IMDD optical transmitter of FIG. 3 during its operation.

FIG. 5B is a schematic view illustrating an embodiment of the conventional IMDD optical receiver of FIG. 4 during its operation.

FIG. 6 is a graph view illustrating an embodiment of the operation of the conventional externally-modulated IMDD optical transmitter of FIG. 3 and the conventional IMDD optical receiver of FIG. 4.

FIG. 7A is a graph view illustrating an embodiment of the operation of the conventional externally-modulated IMDD optical transmitter of FIG. 3 transmitting PAM-4 symbols to the conventional IMDD optical receiver of FIG. 4 using PAM4-modulation.

FIG. 7B is a graph view illustrating an embodiment of the operation of the conventional externally-modulated IMDD optical transmitter of FIG. 3 and the conventional IMDD optical receiver of FIG. 4 using PAM4-modulation.

FIG. 7C is a graph view illustrating an embodiment of the operation of the conventional externally-modulated IMDD optical transmitter of FIG. 3 and the conventional IMDD optical receiver of FIG. 4 using PAM4-modulation.

FIG. 7D is a graph view illustrating an embodiment of the operation of the conventional externally-modulated IMDD optical transmitter of FIG. 3 and the conventional IMDD optical receiver of FIG. 4 using PAM4-modulation.

FIG. 8 is a schematic view illustrating an embodiment of an optical transmitter provided according to the teachings of the present disclosure.

FIG. 9 is a schematic view illustrating an embodiment of an optical receiver provided according to the teachings of the present disclosure.

FIG. 10 is a flow chart illustrating an embodiment of a method for transmitting data in an IMDD optical transceiver system.

FIG. 11 is a schematic view illustrating an embodiment of the optical transmitter of FIG. 8 operating during the method of FIG. 10.

FIG. 12 is a schematic view illustrating an embodiment of the optical transmitter of FIG. 8 operating during the method of FIG. 10.

FIG. 13 is a schematic view illustrating an embodiment of the optical transmitter of FIG. 8 operating during the method of FIG. 10.

FIG. 14 is a schematic view illustrating an embodiment of the optical receiver of FIG. 9 operating during the method of FIG. 10.

FIG. 15 is a schematic view illustrating an embodiment of the optical receiver of FIG. 9 operating during the method of FIG. 10.

FIG. 16 is a schematic view illustrating an embodiment of the optical receiver of FIG. 9 operating during the method of FIG. 10.

FIG. 17 is a schematic view illustrating an embodiment of the optical receiver of FIG. 9 operating during the method of FIG. 10.

FIG. 18A is a graph view illustrating an embodiment of the operation of the optical transmitter of FIG. 8 and the optical receiver of FIG. 9 during the method of FIG. 10.

FIG. 18B is a graph view illustrating an embodiment of the operation of the optical transmitter of FIG. 8 and the optical receiver of FIG. 9 during the method of FIG. 10.

FIG. 19A is a graph view illustrating an embodiment of the operation of the optical transmitter of FIG. 8 and the optical receiver of FIG. 9 during the method of FIG. 10 using PAM-4 symbol transmission.

FIG. 19B is a graph view illustrating an embodiment of the operation of the optical transmitter of FIG. 8 and the optical receiver of FIG. 9 during the method of FIG. 10 using PAM-4 symbol transmission.

FIG. 20A is a graph view illustrating an embodiment of the operation of the optical transmitter of FIG. 8 and the optical receiver of FIG. 9 during the method of FIG. 10 using PAM-8 symbol transmission.

FIG. 20B is a graph view illustrating an embodiment of the operation of the optical transmitter of FIG. 8 and the optical receiver of FIG. 9 during the method of FIG. 10 using PAM-8 symbol transmission.

FIG. 20C is a graph view illustrating an embodiment of the operation of the optical transmitter of FIG. 8 and the optical receiver of FIG. 9 during the method of FIG. 10 using PAM-8 symbol transmission.

FIG. 20D is a graph view illustrating an embodiment of the operation of the optical transmitter of FIG. 8 and the optical receiver of FIG. 9 during the method of FIG. 10 using PAM-8 symbol transmission.

FIG. 21 is a schematic view illustrating an embodiment of an optical transmitter provided according to the teachings of the present disclosure.

FIG. 22 is a schematic view illustrating an embodiment of an optical transmitter provided according to the teachings of the present disclosure.

FIG. 23 is a schematic view illustrating an embodiment of an optical receiver provided according to the teachings of the present disclosure.

FIG. 24 is a schematic view illustrating an embodiment of an optical transmitter provided according to the teachings of the present disclosure.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

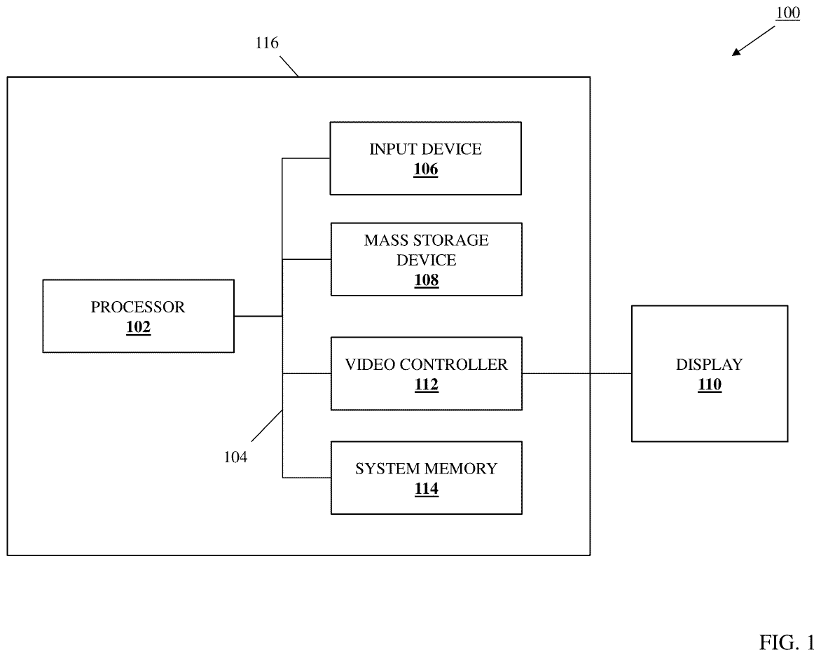

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

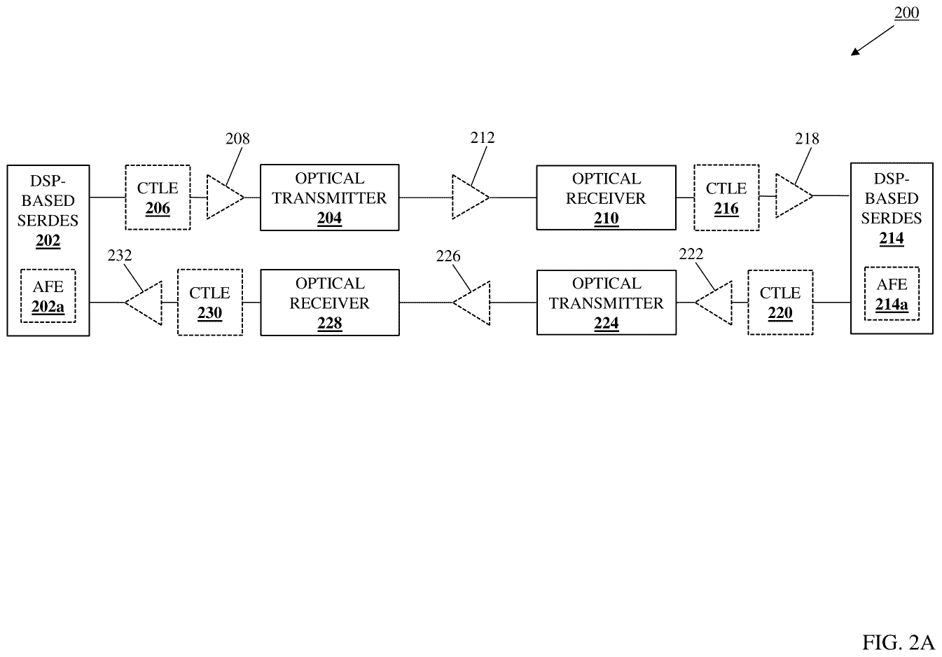

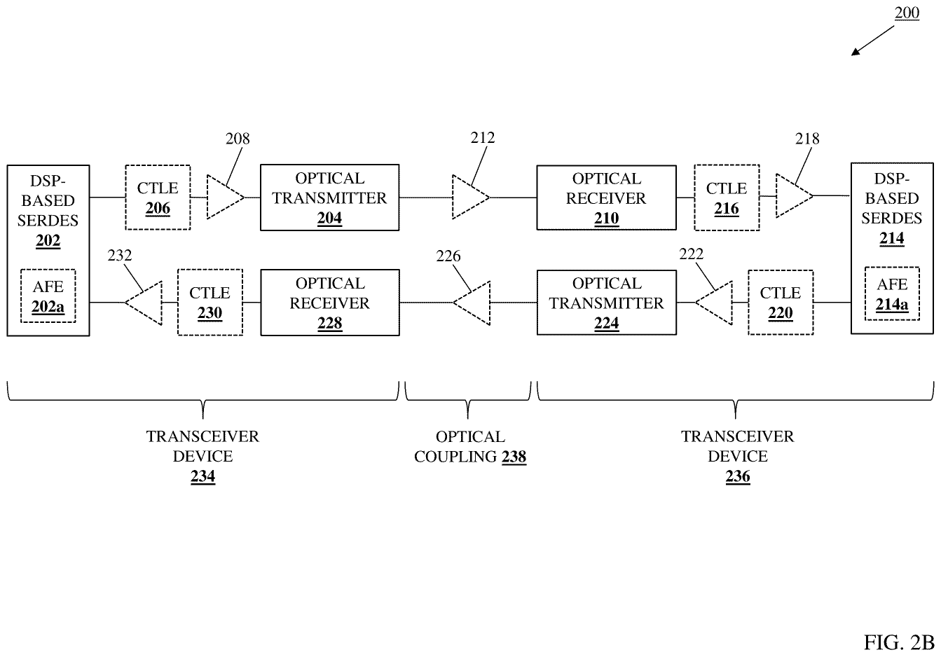

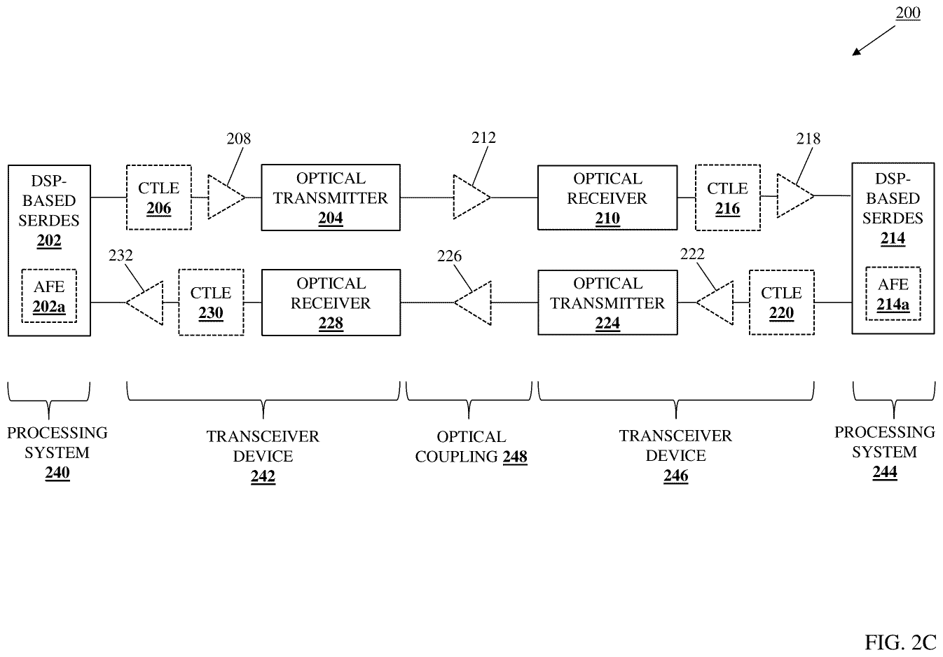

Referring now to FIG. 2A, an embodiment of a networked system 200 is illustrated that may include the IMDD optical transceiver system of the present disclosure. The networked system 200 of FIG. 2A provides a generalized example of the use of optical transmitters and optical receivers, and one of skill in the art in possession of the present disclosure will appreciate how the components of the networked system 200 may be combined in one or more devices, as well as how the electrical and optical connections may be provided over a variety of distances. In the illustrated embodiment, the networked system 200 includes a Digital Signal Processing (DSP)-based SERializer/DESerializer (SERDES) 202 having an optional Analog Front End (AFE) 202a at its input that may be omitted in other embodiments (as indicated by the dashed lines in FIG. 2A). In the illustrated embodiment, the networked system 200 includes an optical transmitter 204 that is electrically coupled to the DSP-based SERDES 202 via an optional Continuous Time Linear Equalizer (CTLE) 206 and an optional high-speed, Radio Frequency (RF) amplifier 208, either or both of which may be omitted in other embodiments (as indicated by the dashed lines in FIG. 2A). For example, one of skill in the art in possession of the present disclosure will appreciate how CTLEs and/or RF amplifiers may be utilized with linear optical transmitters and linear optical receivers that are located more than a threshold distance from a DSP-based SERDES.

The networked system 200 also includes an optical receiver 210 that is optically coupled to the optical transmitter 204 via an optical coupling (e.g., a single-mode optical fiber cable), and in the illustrated embodiment that optical coupling includes an optional optical amplifier 212 that may be omitted in other embodiments (as indicated by the dashed lines in FIG. 2A). In the illustrated embodiment, the networked system 200 includes a DSP-based SERDES 214 having an optional AFE 214a at its input that may be omitted in other embodiments (as indicated by the dashed lines in FIG. 2A), with the DSP-based SERDES 214 (e.g., the optional AFE 214a at the input of the DSP-based SERDES 214) electrically coupled to the optical receiver 210 via an optional CTLE 216 and an optional RF amplifier 218, either or both of which may be omitted in other embodiments (as indicated by the dashed lines in FIG. 2A).

In the illustrated embodiment, the networked system 200 also includes an optical transmitter 224 electrically coupled to the DSP-based SERDES 214 via a CTLE 220 and an optional RF amplifier 222, either or both of which may be omitted in other embodiments (as indicated by the dashed lines in FIG. 2A). The networked system 200 also includes an optical receiver 228 that is optically coupled to the optical transmitter 224 via an optical coupling (e.g., a single-mode optical fiber cable), and in the illustrated embodiment that optical coupling includes an optional optical amplifier 226 that may be omitted in other embodiments (as indicated by the dashed lines in FIG. 2A). In the illustrated embodiment, the DSP-based SERDES 202 (e.g., the optional AFE 202a at the input of the DSP-based SERDES 202) is electrically coupled to the optical receiver 228 via an optional CTLE 230 and an optional RF amplifier 232, either or both of which may be omitted in other embodiments (as indicated by the dashed lines in FIG. 2A).

As will be appreciated by one of skill in the art in possession of the present disclosure, each of the pair of the optical transmitter 204/optical receiver 210 and the pair of the optical transmitter 224/optical receiver 228 operate as an optical transceiver pair that facilitates a link between the DSP-based SERDES 202 and 214 ((e.g., a transmit/receive electro-optical link from the DSP-based SERDES 202 to the DSP-based SERDES 214, and a transmit/receive electro-optical link from the DSP-based SERDES 214 to the DSP-based SERDES 202). Furthermore, one of skill in the art in possession of the present disclosure will appreciate how the networked system 200 may be provided in a variety of manners.

For example, FIG. 2B illustrates an embodiment of a DSP-based retimed transceiver system in which a transceiver device 234 includes the DSP-based SERDES 202, the optical transmitter 204, and the optical receiver 228; a transceiver device 236 includes the DSP-based SERDES 214, the optical transmitter 224, and the optical receiver 210; and the transceiver device 234 is coupled to the transceiver device 236 by an optical coupling 238 that may be provided by a pair of optical fibers with the optional optical amplifiers 212 and 226 discussed above. However, FIG. 2C illustrates an embodiment of a direct-drive un-retimed linear transceiver system in which a processing system 240 includes the DSP-based SERDES 202, a transceiver device 242 includes the optical transmitter 204 and the optical receiver 228 and is coupled to the processing system 240; a processing system 244 includes the DSP-based SERDES 214; a transceiver device 246 includes the optical transmitter 224 and the optical receiver 210 and is coupled to the processing system 244; and the transceiver device 242 is coupled to the transceiver device 246 by an optical coupling 248.

However, while FIG. 2C illustrates and describes the processing systems 240 and 244 as including the DSP-based SERDES 202 and 214, respectively, (e.g., a processing system and DSP-based SERDES may be provided by a single Application Specific Integrated Circuit (ASIC)), one of skill in the art in possession of the present disclosure will appreciate how each processing system 240 and 244 may be distinct from the DSP-based SERDES 202 and 214, respectively (e.g., a DSP-based SERDES may be added as a chiplet to an ASIC that provides the processing system). Furthermore, one of skill in the art in possession of the present disclosure will appreciate that the networked systems illustrated in FIGS. 2B and 2C may be mixed (e.g., with the transceiver device 236 in FIG. 2B coupled to the processing system 240 and transceiver device 242 of FIG. 2C via the optical coupling 238/248).

Furthermore, one of skill in the art in possession of the present disclosure will appreciate how FIG. 2C also illustrates embodiments of the provisioning of the transceiver devices 242 and 246 as Linear Pluggable Optical (LPO) modules, “On-Board Optical” (OBO) elements, or “Near-Packaged Optical” (NPO) or “Co-Packaged Optical” (CPO) elements with their connected processing systems 240 and 244, respectively. For example, the embodiment of FIG. 2C may provide the transceiver devices 242 and 246 using Linear Pluggable Optical (LPO) transceiver devices that include analog electrical amplification and optional CTLEs. In another example, the embodiment of FIG. 2C may provide the transceiver devices 242 and 246 using on-board optical or near-package transceiver devices that are located on a host circuit board and connected to the DSP-based SERDES 202 and 214, respectively, via electrical channels. In yet another example, the embodiment of FIG. 2C may provide the transceiver devices 242 and 246 using Co-Packaged Optical (CPO) transceiver devices that are co-packaged with the DSP-based SERDES 202 and 214, respectively, included with or connected to the processing systems 240 and 244, respectively. In yet another example, the embodiment of FIG. 2C may provide an electrical/optical communication conversion aggregator system like that described in U.S. patent application Ser. No. 19/027,109, attorney docket no. 140389.01, filed on Jan. 17, 2025, and may utilize optical transmitters and optical receivers like the optical transmitters 204 and 224 and the optical receivers 210 and 228.

While the simplified examples above describe transceiver devices having a single optical transmitter/optical receiver pair, one of skill in the art in possession of the present disclosure will appreciate how transceiver devices typically include multiple optical transmitter/optical receiver pairs (e.g., Quad Small Form-factor Pluggable (QSFP) transceiver devices which include four distinct transceiver devices, optical modules standardized by an Optical Internetworking Forum Implementation Agreement that may include up to thirty-two 100G transceiver devices, etc.). Furthermore, while specific examples and configurations of a networked system that may include the IMDD optical transceiver system of the present disclosure have been illustrated and described and are used in the examples provided below, one of skill in the art in possession of the present disclosure will appreciate how the IMDD optical transceiver system of the present disclosure may be provided in a variety of networked systems and/or networked system configurations while remaining within the scope of the present disclosure as well.

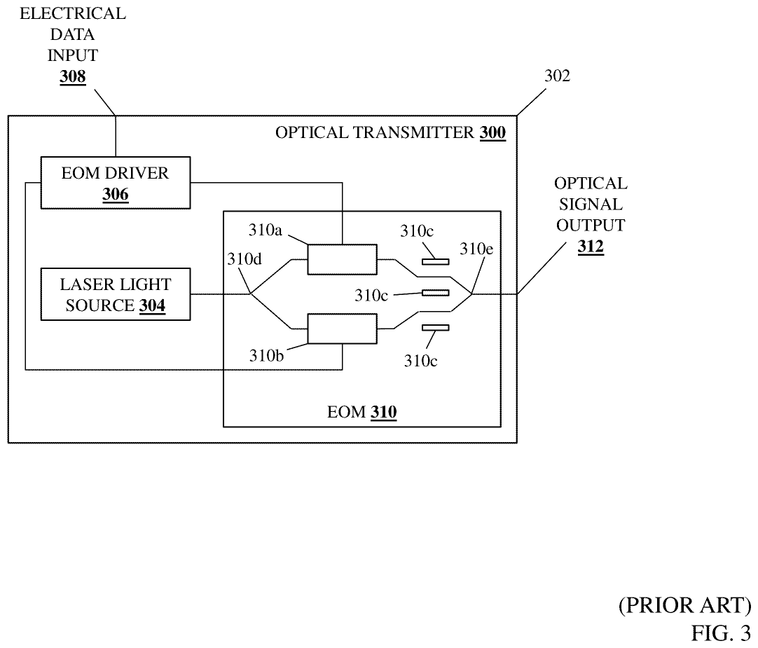

Referring now to FIG. 3, an embodiment of a conventional externally-modulated IMDD optical transmitter 300 is illustrated and described for use in comparing its operation to the operation of optical transmitters provided according to the teachings of the present disclosure. As will be appreciated by one of skill in the art in possession of the present disclosure, the conventional externally-modulated IMDD optical transmitter 300 may be used to provide the optical transmitters 204 and 224 in the networked system 200 of FIGS. 2A-2C in order to provide a conventional IMDD optical transceiver system. As can be seen, the conventional externally-modulated IMDD optical transmitter 300 includes a chassis 302 (e.g., a circuit board) that supports the components of the conventional externally-modulated IMDD optical transmitter 300. The chassis 302 supports a laser light source 304, as well as an Electro-Optical Modulator (EOM) driver 306 that is coupled to an electrical data input 308. The chassis 302 also supports an Electro-Optical Modulator (EOM) 310. The EOM 310 includes a Mach Zehnder Interferometer (MZI) having phase modulators 310a and 310b, as well as a biasing subsystem 310c.

As can be seen, the EOM driver 306 is electrically coupled to each of the phase modulators 310a and 310b, while the laser light source 304 is optically coupled to each of the phase modulators 310a and 310b by an input Y-junction 310d that splits the light output from the laser light source 304 equally to interact with each of the phase modulators 310a and 310b. Furthermore, light having interacted with phase modulators 310a and 310b is optically coupled to an optical signal output 312 via an output Y-junction 310e, and a biasing subsystem 310c is provided to enable the biasing functionality described below. As will be appreciated by one of skill in the art in possession of the present disclosure, while the biasing subsystem 310c is illustrated as located between the phase modulators 310a and 310b and the output Y-junction 310e, the biasing subsystem 310c may be located at different points in the MZI while remaining within the scope of the present disclosure as well.

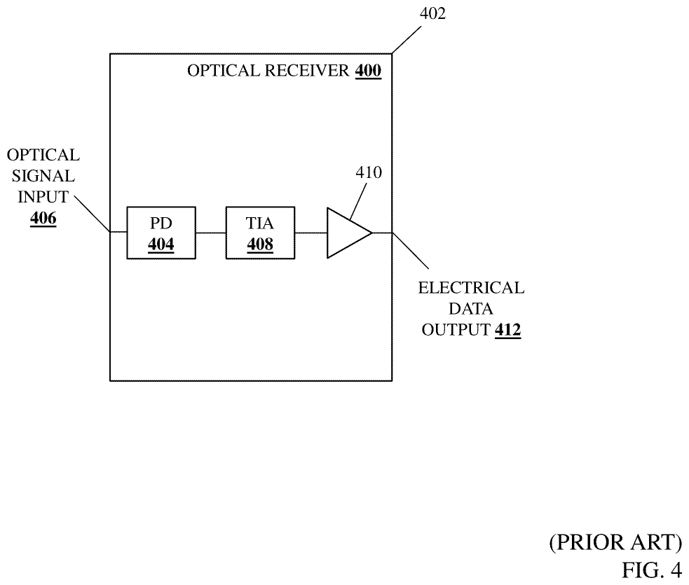

Referring now to FIG. 4, an embodiment of a conventional IMDD optical receiver 400 is illustrated and described for use in comparing its operation to the operation of optical receivers provided according to the teachings of the present disclosure. As will be appreciated by one of skill in the art in possession of the present disclosure, the conventional IMDD optical receiver 400 may be used to provide the optical receivers 210 and 228 in the networked system 200 of FIGS. 2A-2C in order to provide a conventional IMDD optical transceiver system. As can be seen, the conventional IMDD optical receiver 400 includes a chassis 402 (e.g., a circuit board) that supports the discrete components of the conventional IMDD optical receiver 400. The chassis 402 supports a Photo Detector (PD) 404 that is optically coupled to an optical signal input 406, a TransImpedence Amplifier (TIA) 408 that is electrically coupled to the PD 404, an RF amplifier 410 that is electrically coupled to the TIA 408 and to an electrical data output 412.

An example of the operation of the conventional externally-modulated IMDD optical transmitter 300 and the conventional IMDD optical receiver 400 will now be described, and one of skill in the art in possession of the present disclosure will appreciate how the conventional externally-modulated IMDD optical transmitter 300 and the conventional IMDD optical receiver 400 may provide the optical transmitter 204 and the optical receiver 210 discussed above with reference to FIGS. 2A-2C, or the optical transmitter 224 and the optical receiver 228 discussed above with reference to FIGS. 2A-2C. As will be appreciated by one of skill in the art in possession of the present disclosure, the conventional externally-modulated IMDD optical transmitter 300 and the conventional IMDD optical receiver 400 may be coupled to each other by the optical coupling discussed above to provide a single lane IMDD optical interconnect that forms the basis of many conventional optical transceiver devices that have been developed to create Ethernet-compliant solutions for high-speed connectivity over distances that range from less than 2 meters to many kilometers. However, while specific protocols are described, Ethernet protocols, Ultra-Ethernet (UEC) protocols, Infiniband protocols, Fibre Channel protocols, Peripheral Component Interconnect express (PCIe) protocols, Universal Chiplet Interconnect express (UCIe) protocols, Ultra Accelerator Link (UALink) protocols, NVLINK® protocols available from NVIDIA® Corporation of Santa Clara, California, United States, and/or other protocols will fall within the scope of the present disclosure as well.

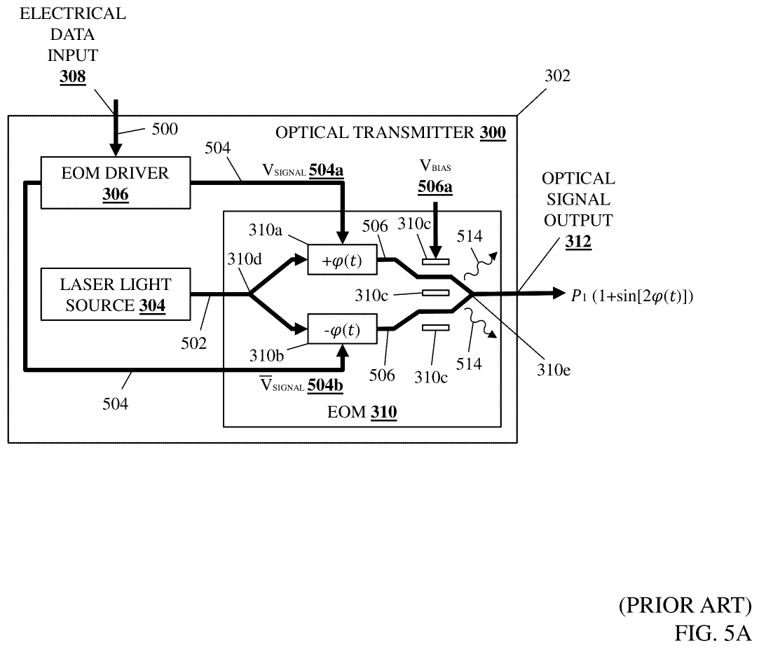

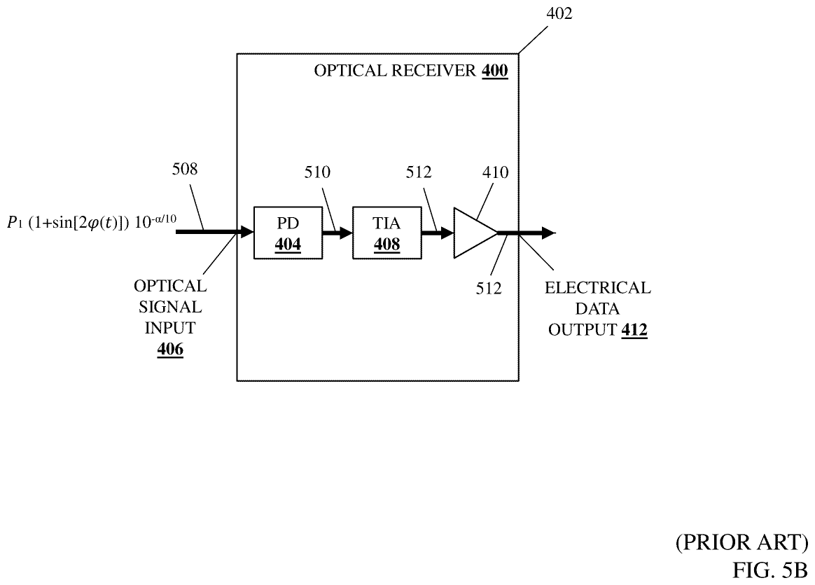

The examples below utilize parameters based on the Institute of Electrical and Electronics Engineers (IEEE) Ethernet standards that provide for the utilization of N-level Pulse Amplitude Modulation (PAM-N) for optical data rates above 25 Gb/s per lane. With reference to FIG. 5A, electronic signal provisioning operations 500 may be performed (e.g., by either of the DSP-based SERDES 202 or 214) to provide a high-speed PAM-N electrical signal via the electrical data input 308 to the EOM driver 306, while the laser light source 304 may perform light provisioning operations 502 that include generating and transmitting light via the input Y-junction 310d to each of the phase modulators 310a and 310b in the MZI provided by the EOM 310 at an optical power of 2P₁. The EOM driver 306 then performs driving operations 504 that include applying a time-varying voltage related to an amplitude of the high-speed, time-varying PAM-N electrical signal to provide an electrical signal V_{SIGNAL} 504a to the phase modulator 310a in the MZI and generate a time-dependent optical phase variation +φ(t) in the lightwaves received from the laser light source 304, and applying a complementary time-varying voltage proportional to the amplitude of the high-speed PAM-N electrical signal to provide an electrical signal V̅_{SIGNAL} 504b to the phase modulator 310b in the MZI and generate a time-dependent optical phase variation −φ(t) in the lightwaves received from the laser light source 304.

Optical signal provisioning operations 506 are then performed on the lightwaves exiting each of the phase modulators 310a and 310b by providing a biasing voltage V_{BIAS} 508 to those lightwaves via the biasing subsystem 310d and then combining those lightwaves at the output Y-junction 310d to provide an intensity modulated optical signal with an optical power of P₁(1+sin[2φ(t)]), with the biasing voltage V_{BIAS} 508 controlling how the intensity modulated optical signal is emitted from the optical transmitter 300 via the optical signal output 312 while ensuring that the signal modulation operates at an optimal point on an EOM electrical voltage-to-output optical signal intensity transfer function curve.

With reference to FIG. 5B, the intensity modulated optical signal will then be transmitted via the optical coupling (e.g., the single-mode optical fiber discussed above) such that it is received by the optical receiver 400 at the optical signal input 406 with an optical power of P₁(1+sin [2φ(t)]) 10^{-α/10} (where a is the optical fiber attenuation (in dB) between the optical transmitter and the optical receiver) and provided to the PD 404. The PD 404 will then perform signal conversion operations 510 that include converting the intensity modulated optical signal into a modulated photocurrent that is proportional to the optical power of the intensity modulated optical signal, and providing that photocurrent to the TIA 408. The TIA 408 and the RF amplifier 410 may then perform electrical signal provisioning operations 512 that include the RF amplifier 410 amplifying the photocurrent to generate an electrical signal, and the TIA 408 matching the impedance of the electrical signal from the PD 404 to the electrical channel it will be transmitted on, and transmitting that electrical signal via the electrical data output 412 and on that electrical channel such that it may be received by the DSP-based SERDES 202 or 214.

As can be seen in FIG. 5A, the optical power of the intensity modulated optical signal transmitted by the optical transmitter 300 is P₁(1+sin [2φ(t)]), as the attenuation of light from the laser light source 304 as part of the optical signal provisioning operations 506 results in “waste light” 514 at the output Y-junction 310e, resulting in approximately one-half of the light provided by the laser light source 304 to the phase modulators 310a and 310b in the MZI being transmitted from the optical transmitter 300 via the optical signal output 312 as the intensity modulated optical signal discussed above, and the rest of that light being radiated and “lost”. As will be appreciated by one of skill in the art in possession of the present disclosure, at some values of the signal voltages V_{SIGNAL} 504a and V̅_{SIGNAL} 504b the optical power of intensity modulated optical signal transmitted by the optical transmitter 300 will be relatively high and the waste light 514 will be relatively low, while at other values of the signal voltages V_{SIGNAL} 504a and V̅_{SIGNAL} 504b the optical power of intensity modulated optical signal transmitted by the optical transmitter 300 will be relatively low and the waste light 514 will be relatively high, with the sum of optical power of intensity modulated optical signal transmitted by the optical transmitter 300 and the waste light 514 remaining constant over time and equal to 2P₁. The inventor of the present disclosure notes that the waste light 514 discussed above has generally not been considered an issue with conventional optical transmitters.

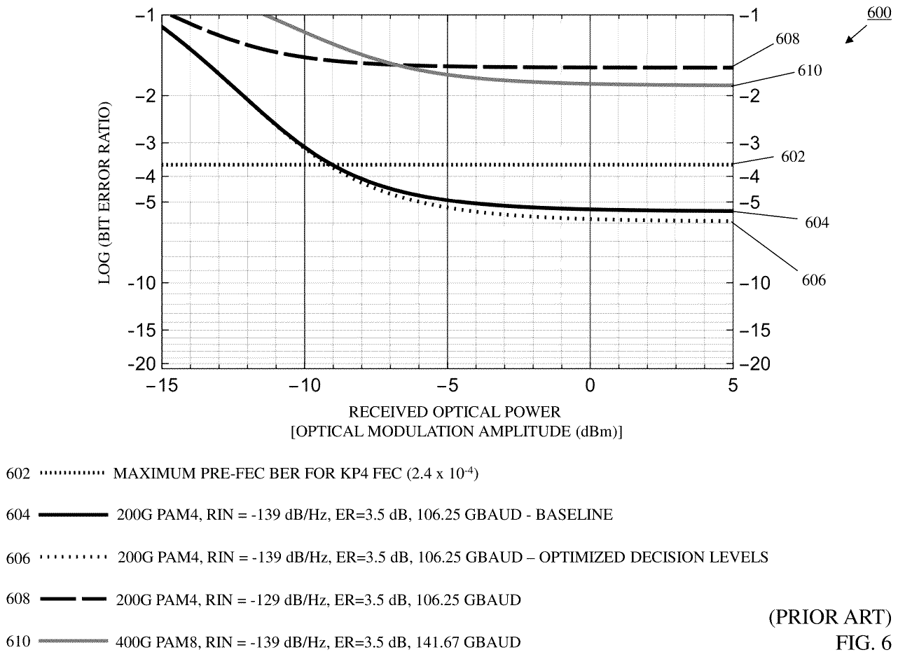

With reference to FIG. 6, a graph 600 is provided that plots a calculated Bit Error Ratio (BER) against a received optical power (e.g., at the PD 404 in the optical receiver 400) for signals transmitted between the conventional optical transmitter 300 and the conventional optical receiver 400 discussed above in different transmission scenarios. As can be seen, a maximum allowable pre-Forward Error Correction (FEC) BER limit 602 was defined as the calculated maximum BER allowable to achieve a 10⁻¹³ BER when using Reed Solomon (544,514) FEC (also referred to as “KP4 FEC” that is used in 100 and 200 Gigabit Ethernet (GbE) single-lane optical channels in IEEE Ethernet). The BER as a function of received optical power was then calculated for the transmission of optical signals using different parameters in the different transmission scenarios, and plotted on the graph 600.

In the illustrated example, a first transmission scenario 604 (and corresponding calculated BER vs. received optical power curve) was defined as a “baseline” transmission scenario using 200G PAM4 (e.g., “BASELINE”) that one of skill in the art in possession of the present disclosure will appreciate is a transmission scenario based on “real-world” parameters provided by commercially available devices. In this “baseline”/first transmission scenario 604, the transmitted PAM4 optical signal is characterized by a Relative Intensity Noise (RIN) of −139 dB/Hz, an Extinction Ratio (ER) of 3.5 dB, and a symbol rate of 106.25 Gigabaud (Gbaud). Furthermore, in the DSP-based SERDES coupled to the optical receiver used in the “baseline”/first transmission scenario 604, decision levels are spaced equidistant between the PAM4 signal levels. In the calculations below, the electrical bandwidth Bₑ is approximately the Nyquist frequency (i.e., one-half of the symbol rate), the PD efficiency is 1 mA/wW, and the thermal noise iₜₕ is 17 pA/√Hz. These parameters for this “baseline”/first transmission scenario 604 using 200G PAM4 are based on the worst-case scenario parameters from the 200 Gb/s per lane single-mode optical physical media dependent standards (200GBASE-DR1) developed by the IEEE, and one of skill in the art in possession of the present disclosure will appreciate how many conventional optical transceiver devices available from a variety of optical transceiver suppliers satisfy this standard.

A second transmission scenario 606 (and corresponding calculated BER vs. received optical power curve) was defined using 200G PAM4, with the transmitted PAM4 optical signal characterized by a RIN of −139 dB/Hz, an ER of 3.5 dB, and a symbol rate of 106.25 Gbaud, and with decision levels optimized for the minimum BER in the DSP-based SERDES that is coupled to the optical receiver used in the second transmission scenario 606 (e.g., “OPTIMIZED DECISION LEVELS”). A third transmission scenario 608 (and corresponding calculated BER vs. received optical power curve) was defined using 200G PAM4, with the transmitted PAM4 optical signal characterized by a RIN of −129 dB/Hz, an ER of 3.5 dB, and a symbol rate of 106.25 Gbaud, and with decision levels spaced equidistant between the PAM4 signal levels in the DSP-based SERDES that is coupled to the optical receiver used in the third transmission scenario 608. A fourth transmission scenario 610 (and corresponding calculated BER vs. received optical power curve) was defined using 400G PAM8, with the transmitted PAM8 optical signal characterized by a RIN of −139 dB/Hz, an ER of 3.5 dB, and a symbol rate of 141.67 Gbaud, and with decision levels spaced equidistant between the PAM4 signal levels in the DSP-based SERDES that is coupled to the optical receiver used in the fourth transmission scenario 610.

As can be seen in the graph 600, the calculated BER decreases with increasing received optical power. One of skill in the art in possession of the present disclosure will appreciate that a viable system requires signals to be transmitted with a BER that is less than the maximum allowable pre-FEC BER limit 602, and the point at which the calculated BER/received optical power curve for any particular transmission scenario with any particular characteristics crosses the maximum allowable pre-FEC BER limit 602 is the minimum received optical power required for the optical signal in that transmission scenario to be viable. Furthermore, one of skill in the art in possession of the present disclosure will recognize that it is desirable to transmit signals with the lowest possible BER and received optical power in order to allow added design margins and make the system more robust.

As such, one of skill in the art in possession of the present disclosure will appreciate how the graph shows that the third transmission scenario 608 (the 200G PAM4 signal with a higher RIN than the other 200G PAM4 transmission scenarios) and the fourth transmission scenario 610 (e.g., the 400G PAM8 signal) both exceed the maximum allowable pre-FEC BER limit 602 and thus are not viable and cannot be used to provide a viable system. Meanwhile, the first transmission scenario 604 (the “baseline” transmission scenario using the 200G PAM4 signal) crosses the maximum allowable pre-FEC BER limit 602 at a received optical power of approximately −9 dBm and has a “BER noise floor” of between 10⁻⁵ and 10⁻⁶, while the second transmission scenario 606 (the 200G PAM4 signal using optimized decision level) does not substantially change the received optical power but lowers the “BER noise floor” of the first optical signal 604 to approximately 10-6.

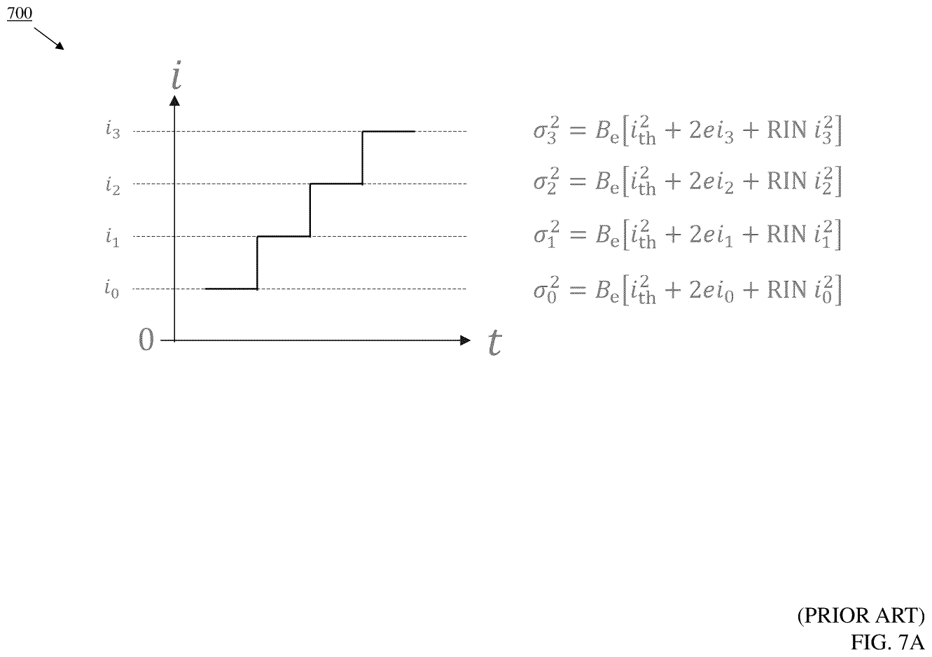

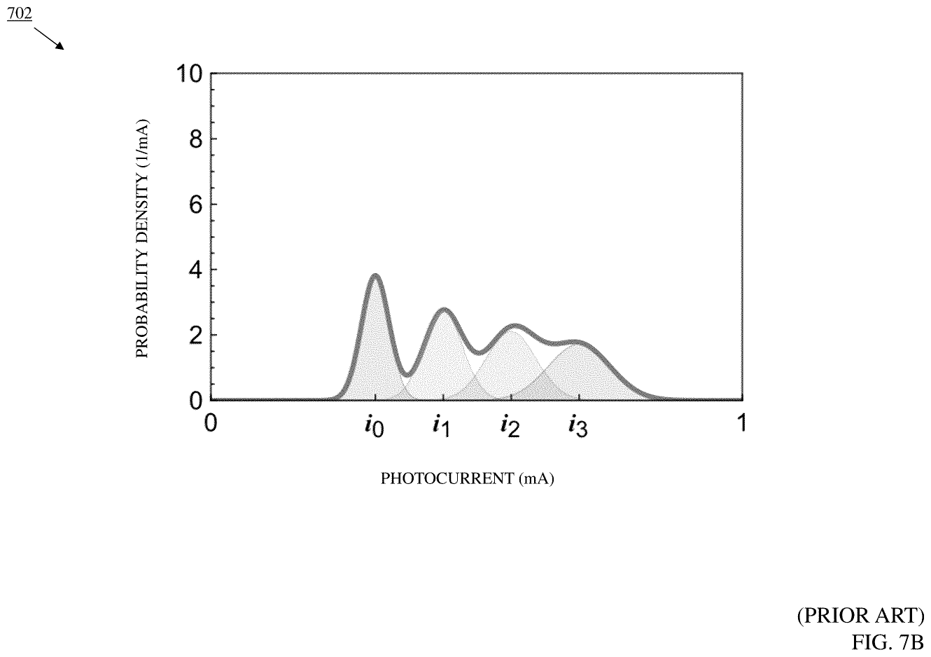

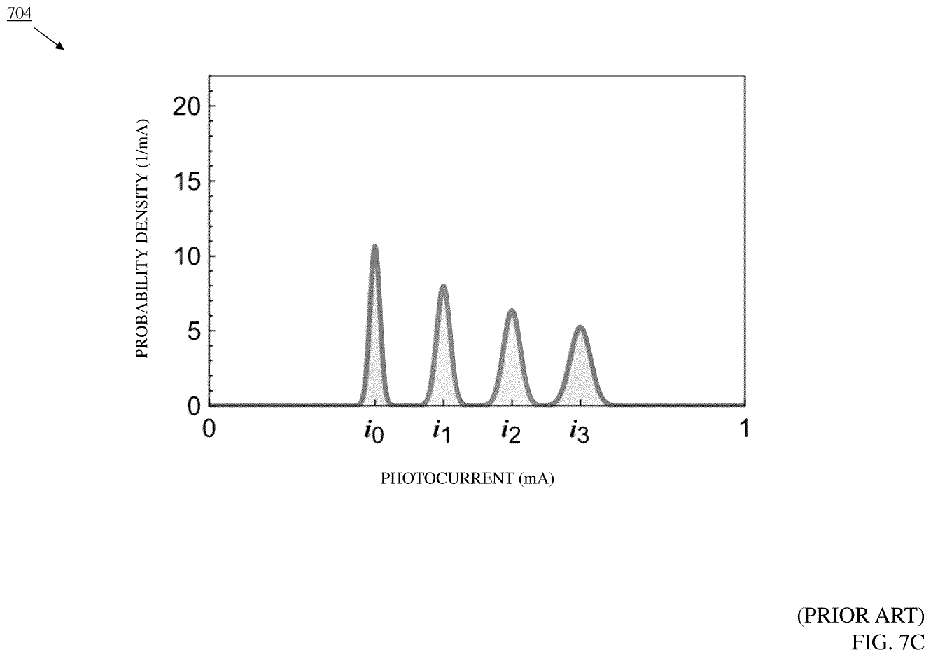

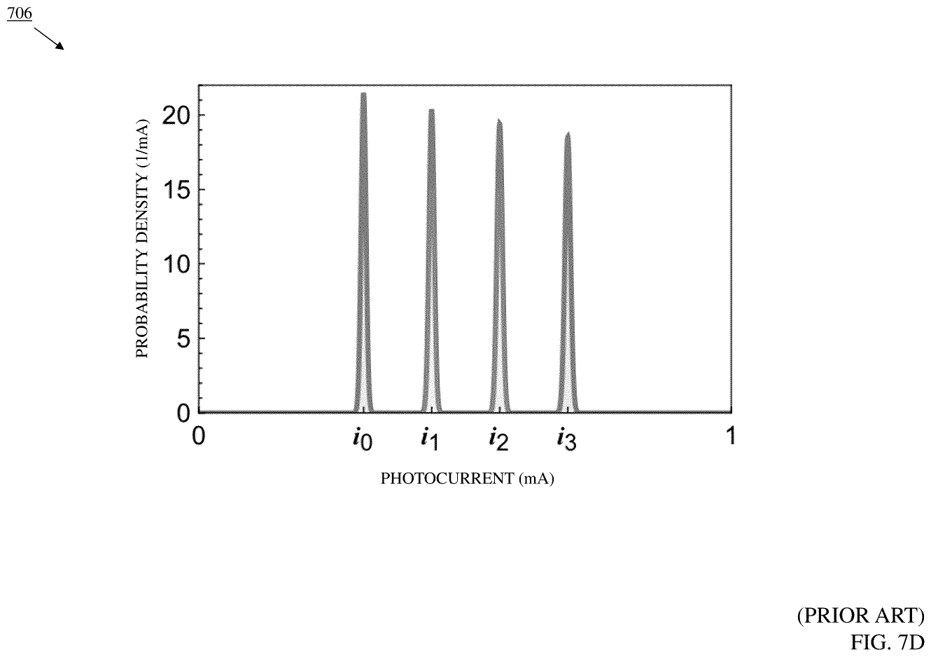

With reference to FIG. 7A, a graph 700 is provided that illustrates the photocurrent level in of electrical signals derived from measurements taken at the RF amplifier 410 in the conventional optical receiver 400 based on four PAM4 symbols (i.e., photocurrent levels i₀, i₁, i₂, and i₃, with the symbol levels equally spaced such that i₃−i₂=i₂−i₁=i₁−i₀=δ), as well as equations for a photocurrent noise power σₙ² for each electrical photocurrent symbol level (i.e., σ₀², σ₁², σ₂², and σ₃²). In the equations for the photocurrent noise power σₙ², Bₑ is the electrical bandwidth of the conventional optical receiver 400, iₜₕ is the thermal equivalent noise, e is the electron charge, iₙ is the photocurrent corresponding to PAM4 symbol n, and RIN is the relative intensity noise of the laser light source 304 in the conventional optical transmitter 300, with the equations generating a photocurrent noise power σₙ² described by a normal/Gaussian probability distribution with a standard deviation σₙ.

With reference to FIGS. 7B, 7C, and 7D, graphs 702, 704, and 706, respectively, are provided to illustrate calculated Gaussian probability distributions for a 200G PAM4 signal having −3 dBm received optical power (e.g., a receive optical power measured by an Optical Modulation Amplitude (OMA)) at the PD 404 in the conventional optical receiver 400, as well as an ER of 3.5 dB, a data rate of 212.50 Gb/s, and a symbol rate of 106.25 Gbaud, and with a thermal noise iₜₕ of 17 pA/√Hz (which one of skill in the art in possession of the present disclosure will appreciate has been selected to match real-world commercial products). In the graph 702 the signal had a relatively high RIN of −129 dB/Hz that resulted in a calculated BER of 3.4×10⁻², in the graph 704 the signal had a RIN of −139 dB/Hz that resulted in a calculated BER of 6.9×10⁻⁶, and in the graph 706 the signal had a relatively low RIN of −165 dB/Hz that resulted in a calculated BER of 1.0×10⁻⁴⁸. As will be appreciated by one of skill in the art in possession of the present disclosure, the RIN of laser light sources is inversely related to cost, and high noise laser light sources generally cost less than low noise laser light sources.

One of skill in the art in possession of the present disclosure will appreciate how the equations for the photocurrent noise power σₙ² include the iₙ² term for the RIN noise that results in an increase in the width of the noise around each symbol level with photocurrent iₙ, with increases in noise as symbol level photocurrent iₙ increases. As can be seen in FIGS. 7B, 7C, and 7D, the lowest photocurrent symbol levels in each graph has the narrowest noise curves. Furthermore, the total probability density distribution is sum of the probability distribution of each level, with the levels becoming relatively indistinguishable and having unacceptably high BER for signals with the highest noise (i.e., the RIN of −129 dB/Hz in graph 702), while the levels become more distinguishable with a relatively low BER for signals with lower noise (i.e., the RIN of −139 dB/Hz in graph 704, and the RIN of −165 dB/Hz in graph 706).

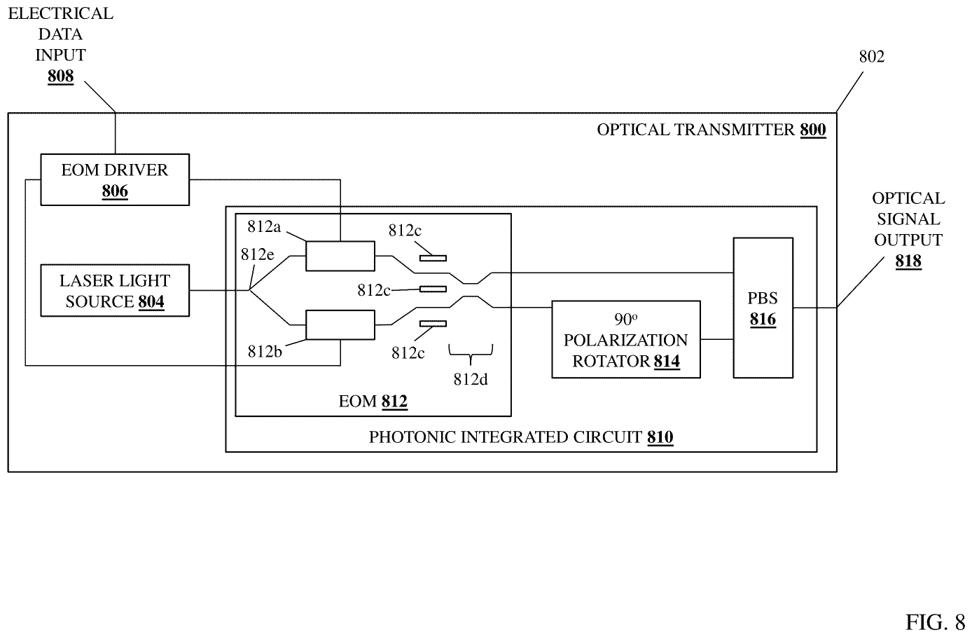

Referring now to FIG. 8, an embodiment of an optical transmitter 800 is illustrated that may be provided according to the teachings of the present disclosure. As will be appreciated by one of skill in the art in possession of the present disclosure, the optical transmitter 800 may be used to provide the optical transmitters 204 and 224 in the networked system 200 of FIGS. 2A-2C in order to provide an IMDD optical transceiver system according to the teachings of the present disclosure. In the illustrated embodiment, the optical transmitter 800 includes a chassis 802 (e.g., a circuit board) that supports the components of the optical transmitter 800, only some of which are illustrated and described below. For example, the chassis 802 may support a laser light source 804, although one of skill in the art in possession of the present disclosure will appreciate how the laser light source 804 discussed below may be separate from the optical transmitter 800 and may be coupled to the optical transmitter 800 by one of more optical amplifiers in other embodiments. The chassis 802 also supports an Electro-Optical Modulator (EOM) driver 304 that is coupled to an electrical data input 808 on the chassis 802.

The chassis 802 also supports a photonic integrated circuit 810. The photonic integrated circuit 810 includes an Electro-Optical Modulator (EOM) 812 that is optically coupled to the laser light source 804 and electrically coupled to the EOM driver 806. The EOM 812 provides a Mach Zehnder Interferometer (MZI) having phase modulators 812a and 812b, a biasing subsystem 812c, and an optical directional coupler 812d. The photonic integrated circuit 810 also includes a 90° polarization rotator 814 that is optically coupled to the EOM 812, and a Polarization Beam Splitter (PBS) 816 that is optically coupled to the EOM 812, the 90° polarization rotator 814, and an optical signal output 818 on the chassis 802.

As can be seen, the EOM driver 806 is electrically coupled to each of the phase modulators 812a and 812b in the EOM 812, while the laser light source 804 is optically coupled via an input Y-junction 812e to interact with of the phase modulators 812a and 812b to provide equal portions of the light output from the laser light source 804 to each of the phase modulators 812a and 812b. Furthermore, the phase modulator 812a is optically coupled to a first/“top left” input on the optical directional coupler 812d in FIG. 8, the phase modulator 812b is optically coupled to a second/“bottom left” input on the optical directional coupler 812d in FIG. 8, with the portion of those optical couplings between the phase modulators 812a and 812b and the optical directional coupler 812d is located adjacent the biasing subsystem 812c to enable the biasing functionality described below (although other locations of the biasing subsystem 812c will fall within the scope of the present disclosure as well). Furthermore, the first/“top right” output on the optical directional coupler 812d is optically coupled to the PBS 816 in FIG. 8, and the second/“bottom right” output on the optical directional coupler 812d is optically coupled to the 90° polarization rotator 814 in FIG. 8.

As will be appreciated by one of skill in the art in possession of the present disclosure, the EOM 812 is illustrated and described in the examples herein as MZI with dual differential drive, and may be provided in various manners in order to produce the complementary 180° out-of-phase optical signals described below (e.g., using the optical signal polarization combination/multiplexing functionality) and provide the electrical/optical signal path lengths discussed below within some tolerance. In a specific example, the EOM 812 may be provided with a ring resonator design, may be provided by a reflective modulator, and/or may be provided in a variety of other manners that will fall within the scope of the present disclosure. Furthermore, while one of skill in the art in possession of the present disclosure will appreciate how dual-differential drive EOMs may provide advantages, single-sided driven EOM will fall within the scope of the present disclosure as well. Further still, the use of EOMs with segmented phase modulators will fall within the scope of the present disclosure. Yet further still the Y-junction 812e and/or the optical differential coupler 812d in the EOM 812 may be provided using MultiMode Interferometers (MMIs) while remaining within the scope of the present disclosure as well.

In some embodiments, a variety of sensors, actuators, and electronic circuits (e.g., providing feedback) may be used to perform control operations (e.g., to control of voltages, temperatures, electric fields at various locations within the system) in order to maintain the operational requirements described herein. For example, optical taps and/or monitor photodetectors may be provided to ensure that a bias voltage for the biasing subsystem 812c is adjusted to ensure that the EOM 812 always operates in quadrature, to provide fine control and stability to the parameters of the optical differential coupler 812d, or to fine tune optical path differences as described below. However, while a specific optical transmitter 800 has been illustrated and described, one of skill in the art in possession of the present disclosure will appreciate how optical transmitters provided according to the teachings of the present disclosure may include a variety of components and/or configurations that will fall within the scope of the present disclosure as well.

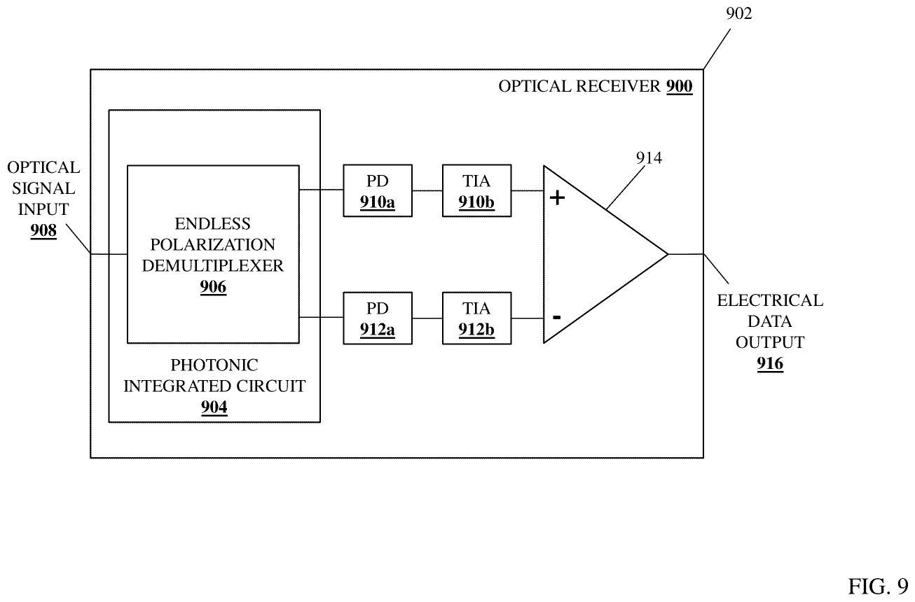

Referring now to FIG. 9, an embodiment of an optical receiver 900 is illustrated that may be provided according to the teachings of the present disclosure. As will be appreciated by one of skill in the art in possession of the present disclosure, the optical receiver 900 may be used to provide the optical receivers 210 and 228 in the networked system 200 of FIGS. 2A-2C in order to provide an IMDD optical transceiver system according to the teachings of the present disclosure. In the illustrated embodiment, the optical receiver 900 includes a chassis 902 (e.g., a circuit board) that supports the components of the optical receiver 900, only some of which are illustrated and described below. For example, the chassis 902 may support a photonic integrated circuit 904 that includes an endless polarization demultiplexer 906 that is optically coupled to an optical signal input 908 on the chassis 902.

The optical receiver 900 also includes a first optical/electrical conversion subsystem that, in the illustrated example, includes a Photo Detector (PD) 910a that is optically coupled to the endless polarization demultiplexer 906 and a TransImpedence Amplifier (TIA) 910b that is electrically coupled to the PD 910a, and a second optical/electrical conversion subsystem that, in the illustrated example, includes a PD 912a that is optically coupled to the endless polarization demultiplexer 906 and a TIA 912b that is electrically coupled to the PD 910a. The optical receiver 900 also includes a signal combination subsystem 914 that includes respective inputs that are electrically coupled to the TIAs 910b and 912b, as well as an output that is electrically coupled to an electrical data output 916 on the chassis 902. However, while the first and second optical/electrical conversion subsystems and the signal combination subsystem 914 are illustrated as being provided outside of the photonic integrated circuit 904, one of skill in the art in possession of the present disclosure will appreciate how any of the first optical/electrical conversion subsystem, the second optical/electrical conversion subsystem, and/or the signal combination subsystem 914 may be included in the photonic integrated circuit 904 while remaining within the scope of the present disclosure as well.

As will be appreciated by one of skill in the art in possession of the present disclosure, the is illustrated and described below as being provided by a differential amplifier, but may be provided by a two-input Differential Signal Processor (e.g., which may be included in either of the DSP-based SERDES 202 or 214 discussed above with reference to FIGS. 2A, 2B, and 2C), an integrated circuit, and/or other signal combination subsystems while remaining within the scope of the present disclosure as well.

As will be appreciated by one of skill in the art in possession of the present disclosure, the functionality of the PDs 910a and 912a, the TIAs 910b and 912b, and the signal combination subsystem 914 may be provided in various manners, and each of those components (or their functionality) may be integrated into the optical receiver 900 in order to achieve a lower total number of devices in the optical receiver 900. To provide a specific example, one of skill in the art in possession of the present disclosure will appreciate how intradyne coherent receivers such as the “IN6450TA” 64 Gbaud Dual-Channel, Differential Input Linear Transimpedance/Variable-Gain Amplifier manufactured by MARVELL® Corporation of Santa Clara, California, United States may be utilized in various embodiments of the present disclosure. As will be appreciated by one of skill in the art in possession of the present disclosure, the IN6450TA discussed above may be configured to provide information on voltages measured on “effective” TIAs 910b and 912b that may be calibrated to provide the relative optical powers detected at PDs 910a and 912a, and this and similar information may be communicated to control loops local to the endless polarization demultiplexer 906, microprocessor control units local to optical receiver 900 or transceiver devices 234 or 236, or to the DSP-based SERDES 202 or 214 (which may be included in the transceiver devices 234 or 236 or embedded in the processing systems 240 or 244 as described above). As will be appreciated by one of skill in the art in possession of the present disclosure, such information may be utilized to enhance and/or simplify the operations of the endless polarization demultiplexer 906 or DSP-based SERDES 202 or 214, may be communicated to the optical transmitter 800, microprocessor units near or local to the optical transmitter 800, the or the DSP-based SERDES from which data is received via the electrical data input 808 in order to enhance or simplify the performance of the optical transmitter 800, optical receiver 900, or networked system 200.

As will be appreciated by one of skill in the art in possession of the present disclosure, in some embodiments the endless polarization demultiplexer 906 is not required and may be replaced with a passive polarization beam splitter that operates as a passive polarization demultiplexer. Such a passive polarization demultiplexer may be used in cases where optical coupling 248 (which is assumed to include “standard single mode optical fiber” and optional “standard” optical amplifiers) is replaced by polarization-preserving or polarization-maintaining single-mode optical fiber and optional polarization-preserving or polarization-maintaining optical amplifiers. One of skill in the art in possession of the present disclosure will appreciate how the elimination of the “active” endless polarization demultiplexer 906 simplifies and lowers costs, as well as how cost-optimization of the networked system 200 would weigh the cost of maintaining polarization via polarization-maintaining fiber in the optical coupling 248 against the cost of the endless polarization demultiplexer 906 (e.g., polarization maintaining fiber has been too expensive for use as a transmission fiber within a data center, although may make sense in AI fabric scale-up scenarios where distances are only a few meters. However, while a specific optical receiver 900 has been illustrated and described, one of skill in the art in possession of the present disclosure will appreciate how optical receivers provided according to the teachings of the present disclosure may include a variety of components and/or configurations that will fall within the scope of the present disclosure as well.

As will be appreciated by one of skill in the art in possession of the present disclosure and as discussed below, the propagation time for the optical propagation of both first and second signals in the same single mode optical fiber should differ by no more than a maximum time difference ΔTₘₐₓ. As will be appreciated by one of skill in the art in possession of the present disclosure, if first and second signals were coupled to separate and distinct optical fibers, it would be difficult to match fiber lengths that may be many hundreds of meters long to a precision of ~100 microns. Another embodiment of the present disclosure may include the use of a multi-core core optical fiber in which a single optical fiber contains multiple single-mode cores as a transmission medium for the optical coupling 238 or 248 from the optical transmitter 204, along with the removal of the polarization rotator 814 and PBS 816. In such an embodiment, the “upper right” output of directional coupler 212d carrying the first optical signal within the optical transmitter 204 is coupled to a first core of the multi-core fiber, and the “lower right” output of directional coupler 212d carrying the second optical signal in the optical transmitter 204 is coupled to a different, second distinct core in that same multi-core fiber, and the lengths of the optical paths from first and second optical signals from the “upper right” and “lower right” outputs of directional coupler 812d of the optical transmitter 800 to the first and second cores of the multi-core fiber differ by less than a quantity equivalent an optical propagation time of ΔTₘₐₓ. Furthermore, that multi-core optical fiber may be coupled to the optical receiver 210 in which the endless polarization demultiplexer 906 has been omitted, with the first optical signal from the first core coupled to PD 910a of the optical receiver 210, the second optical signal from the second core of the multi-core fiber coupled to PD 912a of the optical receiver 210, and the lengths of the optical paths from first and second optical signals from the first and second cores of the PDs 910a and 912a in the optical receiver differing by less than a quantity equivalent to the optical propagation time of ΔTₘₐₓ. One of skill in the art in possession of the present disclosure will appreciated that the optical coupling 238 or 248 between the optical transmitter 224 and the optical receiver 228 may include the same or similar multi-core optical fiber, with the optical transmitter 224 and optical receiver 228 modified similarly as described above.

With respect to photonic integrated circuits used in the optical transmitter 800 and optical receiver 900 discussed above, one of skill in the art in possession of the present disclosure will be appreciate how those photonic integrated circuits may be fabricated in various substrates including silicon (Si) (known as silicon photonics) substrates, silicon nitride (Si₃N₄) substrates, indium phosphide (InP) substrates, lithium niobate (LiNbO₃) substrates, lithium tantalate (LiTaO₃) substrates. barium titanate (BaTiO₃) substrates, various organic substrates, and/or other substrates that would be apparent to one of skill in the art in possession of the present disclosure. Furthermore, one of skill in the art in possession of the present disclosure would recognize how various hybrid approaches may be utilized to provide those photonic integrated circuits such as, for example, the use of a different material (e.g., InP bonded to silicon photonics, thin film LiNbO₃ bonded to silicon photonics, etc.) bonded to one of these substrates to provide the phase modulators 812a and 812b.

With reference to FIGS. 2B, 2C, 8, and 9, the optical transmitter 800 and optical receiver 900 may provide the optical transmitter 204 and the optical receiver 210 that are coupled together via the optical coupling 238 or 248, or may provide the optical transmitter 224 and the optical receiver 228 that are coupled together via the optical coupling 238 or 248. In either situation, the optical transmitter 800 and the optical receiver 900 provide a first electrical/optical signal path and a second electrical/optical signal path that is distinct from the first electrical/optical signal path. As will be appreciated by one of skill in the art in possession of the present disclosure, the first and second electrical/optical signal paths include spatially distinct portions along with other portions in which signals co-propagate along a common optical path (e.g., in the optical coupling after the PBS 816 and prior to the endless polarization demultiplexer 906). As discussed below, where common optical paths are shared, optical signals will propagate through those common optical paths with orthogonal states of polarization.

As will be appreciated by one of skill in the art in possession of the present disclosure, the design of the EOM 802 which includes the combined Mach Zehnder modulator/directional coupler 812a 812b, 812c, 812d, 812e, is linked with the design of EOM driver 806. The path lengths of electrical connections from the EOM 806 carrying V_{SIGNAL} and its complement V̅_{SIGNAL} to phase modulators 812a and 812b may be coordinated with the operation of EOM 806, the operation V_{bias} 1104, and the design of the directional coupler 802d as to operate the EOM 806 at quadrature such that the optical signals at emerging from the “upper right” output of directional coupler 802d (also referred to as the “first” optical signal below) and the optical signal emerging from the “lower right” output of directional coupler 812d (also referred to as the “second” optical signal below) are synchronized in time and generate intensity modulation on each signals that are. 180° out-of-phase with respect to each other.

In the illustrated examples, the first electrical/optical signal path is measured from the to the “upper right” output of optical directional coupler 812d through the PBS 816, out of the optical signal output 818, via the optical coupling 238 or 248, in through the optical signal input 908, through the endless polarization demultiplexer 906, through the first optical electrical conversion subsystem provided by the PD 910a and the TIA 910b, and to the signal combination subsystem 914. Similarly, the second electrical/optical signal path is measured from the “lower right” output of optical directional coupler 812d through the 90° polarization rotator 814, through the PBS 816, out of the optical signal output 818, via the optical coupling 238 or 248, in through the optical signal input 908, through the endless polarization demultiplexer 906, through the second optical electrical conversion subsystem provided by the PD 912a and the TIA 912b, and to the signal combination subsystem 914.

As will be appreciated by one of skill in the art in possession of the present disclosure, in order to provide the combined electrical signal from the signal combination subsystem 914 using the electrical signals from the EOM driver 806 and the light from the laser light source 804, a first time period required to traverse the first electrical/optical signal path and a second time period required to traverse the second/electrical optical signal path must not differ by more than a threshold amount of time ΔT_{MAX}. Furthermore, because the optical transmitter 800 and the optical receiver 900 are coupled together by the same optical coupling (e.g., optical fibers in an optical cable) that provides equal portions of the first electrical/optical signal path and the second/electrical optical signal path, it is only the differences in the first and second electrical/optical signal path lengths in the optical transmitter 800 and the optical receiver 900 that contribute to the threshold amount of time ΔT_{MAX} (e.g., over optical fiber cable distances (e.g., 1 kilometer standard single mode fiber distances) where the effects of differential group delay due to fiber polarization dispersion are sufficiently small).

In an embodiment, the threshold amount of time ΔT_{MAX} may be determined based on an acceptable frequency-domain compression factor CF at the Nyquist frequency f_{N} (i.e., one half the symbol rate as discussed above) and in the current power derived from the combined electrical signal at the output of the signal combination subsystem 914, and may be provided by the equation:

$${cos}^{2} ( 2 π {f}_{N} Δ {T}_{MAX} ) = 1 {0}^{CF [ dB ] / 10}$$

To provide a specific example, a PAM8 signal provided at a data rate of 425 Gb/s, a symbol rate of 141.67 Gbaud that provides a Nyquist frequency f_{N}=70.83 GHz and a maximum compression factor CF of −1 dB at the Nyquist frequency, will result in a threshold amount of time ΔT_{MAX}≤1.1 picoseconds. In a medium with refractive index n, an allowable optical path length difference ϵ=ΔT_{MAX} c/n (where c is the speed of light). For silicon photonics at 1310 nm, n=3.47, resulting in ϵ≤91 μm. As will be appreciated by one of skill in the art in possession of the present disclosure, such an allowable optical path length difference ϵ of no more than 91 μm is about 1000 times the length tolerances required to make the silicon photonics version of the MZI provided by the photonic integrated circuit 810 in the optical transmitter 800, and commercially available single-mode optical fibers can be provided with a nominal polarization mode dispersion of 0.1 picoseconds/√km or less. As such, silicon photonic techniques allow the photonic integrated circuits 810 and 904 in the optical transmitter 800 and the optical receiver 900, respectively, to be configured such that the times required to traverse the first electrical/optical signal path and the second electrical/optical signal path discussed above do not differ by more than the threshold amount of time ΔT_{MAX}, and the quality of the signal as measured at the Nyquist frequency will be degraded by less than the compression factor CF.

Furthermore, one of skill in the art in possession of the present disclosure will appreciate that two criteria may be defined for determining ΔT_{MAX}:1) that the first and second signals combine in the electrical domain at the optical receiver 800 in phase and with minimal compression/fading at the high frequencies, and 2) that the relative intensity noise from the laser light source is completely in phase over all frequencies to achieve maximum RIN cancelation/reduction at the optical receiver 800.

Furthermore, one of skill in the art in possession of the present disclosure will appreciate how the transceiver device 234 or 242 that includes the optical transmitter 208 and optical receiver 228 in FIGS. 2B and 2C may be identical to the transceiver device 236 or 246 that includes the optical transmitter 224 and optical receiver 212 in FIGS. 2B and 2C. As such, the optical transmitter and optical receiver in one of those transceiver devices may be identical to the optical transmitter and optical receiver in the other of those transceiver devices, and thus the optical transmitter and optical receiver in either one of those transceiver devices may be configured to provide the first electrical/optical signal path and the second electrical/optical signal path discussed above that are configured such that the times required to traverse them do not differ by more than the threshold amount of time ΔT_{MAX}.

In other words, transceiver devices may be manufactured that include an optical transmitter providing a first electrical/optical signal path length x₁ and second electrical/optical signal path length y₁, and an optical receiver providing a first electrical/optical signal path length x₂ and second electrical/optical signal path length y₂, and a pair of those transceiver devices will provide a first electrical/optical signal path length x₁+x₂ and second electrical/optical signal path length y₁+y₂ and such that the time required to traverse x₁+x₂ and y₁+y₂ does not differ by more than the threshold amount of time ΔT_{MAX}. Thus, any particular transceiver device will have an optical transmitter and an optical receiver that are configured to provide the first electrical/optical signal path and the second electrical/optical signal path discussed above that are configured such that the times required to traverse them do not differ by more than the threshold amount of time ΔT_{MAX}. One of skill in the art in possession of the present disclosure will appreciate that it may be more beneficial to design transceiver devices with x₁=y₁ and optical receivers with x₂=y₂ in order to provide a tolerance less than ΔT_{MAX} so that universal interoperability of transmitters and receivers can be standardized.

As will be appreciated by one of skill in the art in possession of the present disclosure, the maximum difference in propagation time between the two paths ΔT_{MAX} can be increased by appropriate frequency domain manipulation of the data stream received at the electrical data input 808 on the optical transmitter 800. For example, an operation sometimes referred to as “peaking” may be performed in either the analog domain (e.g. in the CTLE 206 or 220 coupled to the optical transmitters 204 or 224) and/or in the digital domain (e.g., in the DSP-based SERDES 202 or 214 coupled to the optical transmitters 204 or 224). Similarly, ΔT_{MAX} may be increased by appropriate frequency domain manipulation of the data stream provided at the electrical data output 916 in either the analog or digital domains as well, or in a differential signal combining device such as the “IN6450TA” discussed above (or other devices that are configured to receive two electrical inputs originating from the PDs 910a and 910b). Similarly, ΔT_{MAX} may be increased by relaxing the compression factor criteria (i.e. increasing the maximum compression factor allowed at the Nyquist frequency).

As will be appreciated by one of skill in the art in possession of the present disclosure, wavelength division multiplexing may be used with a single optical fiber to carry multiple optical signals, with each wavelength carrying a different and distinct data stream. As such, a plurality of the optical transmitters 800 may each be fed by respective laser light sources having different wavelengths, with the optical output of each of those optical transmitters 800 combined and transmitted over a single fiber using a Wavelength Division Multiplexer (WDM), and a wavelength division de-multiplexer may be used to distinguish each optical signal by its distinct optical wavelength and direct each of those optical signals to a respective optical receiver 900 (one for each wavelength) to transport multiple distinct data streams over a single optical fiber.

Furthermore, one of skill in the art in possession of the present disclosure will appreciate how a single endless polarization de-multiplexer may be used with a single optical fiber carrying multiple wavelength optical signals and a pair of wavelength division de-multiplexer that are each used for a different polarization output from that endless polarization demultiplexer, thus allowing the single endless polarization demultiplexer to be shared across one or more of the optical receivers 800 that have their single endless polarization demultiplexer 906 replaced by two optical inputs each coupled to one of the PDs 910a and 912a. However, one of skill in the art in possession of the present disclosure will appreciate how the polarization mode dispersion of the optical coupling 248 will limit the maximum wavelength span (and thereby number of distinct data streams) that can be effectively be simultaneously demultiplexed by a single endless polarization demultiplexer over a given length of single-mode optical fiber in optical coupling 248.

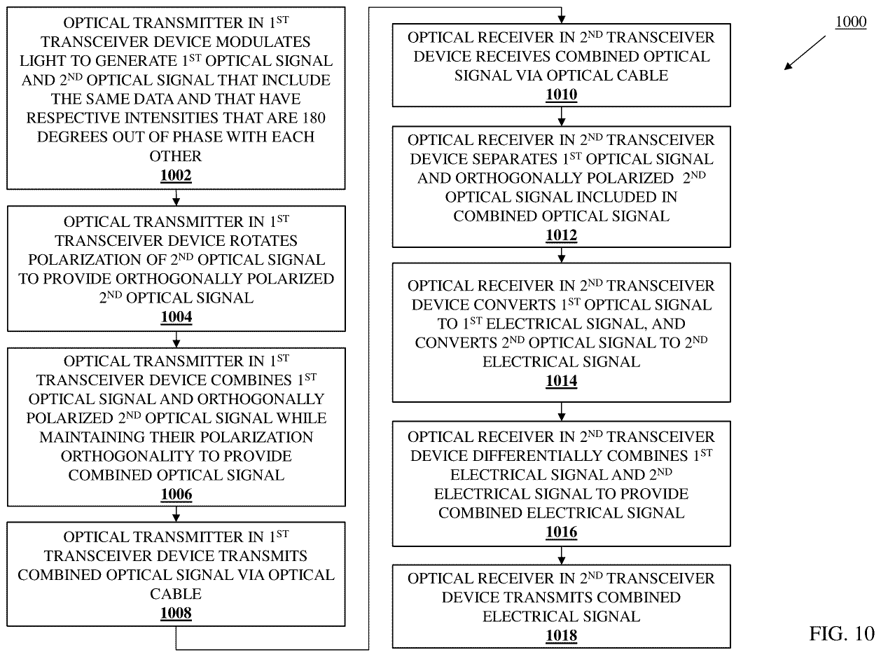

Referring now to FIG. 10, an embodiment of a method 1000 for transmitting data in an Intensity Modulated Direct Detection (IMDD) optical transceiver system is illustrated. As discussed below, embodiments of the systems and methods of the present disclosure include an optical transmitter that rotates a polarization of one of a pair of optical signals that are output from its Mach Zehnder Interferometer before combining them into a combined optical signal that it transmits to an optical receiver, with the optical receiver separating the optical signals, converting them to respective electrical signals, and combining the electrical signals into a combined electrical signal. For example, the IMDD optical transceiver system of the present disclosure may include first and second transceiver devices connected to an optical cable. The first transceiver device modulates light to generate first and second optical signals having the same data and respective 180-degree out-of-phase intensities, rotates a polarization of the second optical signal to provide an orthogonally polarized second optical signal, and combines the first and orthogonally polarized second optical signal while maintaining their relative polarization orthogonality to provide a combined optical signal that it transmits via the optical cable. The first optical receiver receives the combined optical signal via the optical cable, separates the first and orthogonally polarized second optical signal in the first combined optical signal, converts the first and orthogonally polarized second optical signal to first and second electrical signals, respectively, and combines them to provide a combined electrical signal, and transmits the combined electrical signal.

As described below, the IMDD optical transceiver system of the present disclosure enables the transmission of optical signals using higher order modulation, higher speeds, and lower Nyquist frequencies relative to conventional IMDD optical transceiver systems. Furthermore, the IMDD optical transceiver system of the present disclosure raises the value/usefulness of the optimization of decision thresholds, as well as the adjustment of transmission levels at the optical transmitter so that they are not equally separated (i.e., between symbols) but optimized for the transmission scenario, as the present disclosure enables BER improvements via level optimization that are significantly greater than in conventional systems. Additionally, one of skill in the art in possession of the present disclosure will appreciate that the systems and methods of the present disclosure expand the overlap between optimal high-speed electrical signal modulation formats which favors higher modulation orders, and a lower Nyquist frequency, and optimal optical signal modulation which favors a lower order modulation format, thereby making more likely the use of identical modulation formats for both electrical and optical signal.

As described herein, IMDD optical transceiver systems provided according to the teachings of the present disclosure enable higher quality optical signals and reduce the impact of certain signal-dependent noise relative to conventional IMDD optical transceiver systems while consuming the same (or approximately the same) amount of transmitter electrical power due to the recycling and utilization of what is waste light in conventional IMDD optical transceiver systems. In the discussions below, a transmission scenario may be considered to be “better” than another transmission scenario if, when modeled using the same parameters (e.g., transceiver device parameters, optical network parameters, optical transmission parameters, etc.) that transmission scenario has a lower Bit Error Ratio (BER), a lower BER “floor”, and/or a lower minimum receiver optical power requirement to achieve the same BER under some optical network operation conditions relative to the other transmission scenario. In the scenarios described and modeled below, the received optical power is the optical power received at the PD 404 for scenarios involving the conventional systems, and the received optical power is the optical power received at either the PD 910a or the PD 912a only in scenarios involving the teachings of the present disclosure. Furthermore, the modeling does not account for the received optical power at the other PD, because that optical power comes from waste light 504 that is recycled according to the teachings provided herein, and is not utilized in conventional systems.

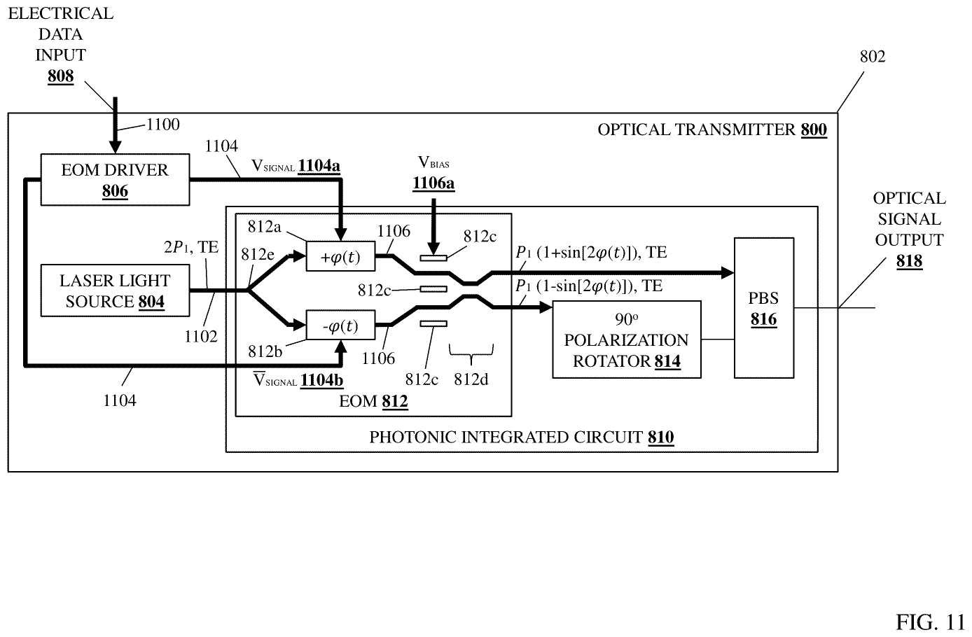

The method 1000 begins at block 1002 where an optical transmitter in a first transceiver device modulates light to generate first optical signals and second optical signals that include the same data and that include respective intensities that are 180 degrees out of phase. With reference to FIG. 11, in an embodiment of block 1002, electronic signal provisioning operations 1100 may be performed (e.g., by either of the DSP-based SERDES 202 or 214) to provide a high-speed PAM-N electrical signal via the electrical data input 808 to the EOM driver 806, while the laser light source 804 may perform light provisioning operations 1102 that include generating and transmitting light via the input Y-junction 812e to interact with each of the phase modulators 812a and 812b in the MZI provided by the EOM 812 with an optical power of P₁ at each modulator. The EOM driver 806 then performs driving operations 1104 that include applying a time-varying voltage related to the amplitude of the high-speed PAM-N electrical signal to provide an electrical signal V_{SIGNAL} 1104a to the phase modulator 812a in the MZI and generate a time-dependent optical phase variation +φ(t) in the lightwaves received from the laser light source 804, and applying a complementary time-varying voltage related to the amplitude of the high-speed PAM-N electrical signal to provide an electrical signal V̅_{SIGNAL} 1104b to the phase modulator 812b in the MZI and generate a time-dependent optical phase variation −φ(t) in the lightwaves received from the laser light source 804.

Light from phase modulator 812a then enters the “upper left” input to directional coupler 812d, while light from phase modulator 812b enters the “lower left” input to directional coupler 812d. The function of directional coupler 812b is to provide a first optical signal at the “upper right” output directly related to the sum of the complex electric field of the lightwave entering the “upper left” input to directional coupler 812d designated by E₁e^{+iφ(t)} and the complex electric field of the lightwave entering the “lower left” input to directional coupler 812d designated by E₁e^{-iφ(t)} where the optical power, P₁is proportional to |E₁|². Similarly and simultaneously, directional coupler 812b provides a second optical signal at the “lower right” output of directional coupler 812d directly related to the difference between the complex electric field of the lightwave entering the “upper left” input to directional coupler 812d designated by E₁e^{+iφ(t)} and the complex electric field of the lightwave entering the “lower left” input to directional coupler 812d designated by E₁e^{-iφ(t)}. By taking the sums and differences of these electric fields, and using the fact that the optical output power at each output of directional coupler 212d is proportional to |Eₒᵤₜₚᵤₜ|², one arrives at a first optical signal with a power of P₁ (1+sin [2φ(t)]) at the “upper right” output of directional coupler optical 812d and a second optical signal with a power of P₁ (1−sin [2φ(t)]) at the “lower right” output of directional coupler optical 812d. Therefore, the transceiver 800 has generated a first optical signal and a second optical signal that carry the same information/data, but have respective optical intensities that are 180 degrees out of phase with respect to each other. As will be appreciated by one skilled in the art, a bias voltage V_{BIAS} 1106a is applied to EOM 812 to ensure that the EOM 812/directional coupler 812d operate at the quadrature point and the equations describing the optical power relationships between the first and second optical signals in FIG. 11 remain valid.

Optical signal provisioning operations 1106 are then performed on the first optical signal and the second optical signal exiting the “upper right” and “lower right” outputs of directional coupler 812d, respectively, by directing to the PBS 608 the first optical signal from the “upper right” output of directional coupler 812d with an optical power P₁ (1+sin [2φ(t)]), and providing the second optical signal from “lower right” output of the directional coupler 812d, with an optical power P₁ (1−sin [2φ(t)]) to the 90° polarization rotator 814. As will be appreciated by one of skill in the art in possession of the present disclosure, the optical directional coupler 812d provides for the recovery/recycling of the waste light 514 that is otherwise produced by the conventional optical transmitter 300 as discussed above with reference to FIG. 5A in order to provide the second optical signal, which as discussed below improves the effective signal-to-noise ratio of the combined electrical signal provided by the optical receiver 900.

As will be appreciated by one of skill in the art in possession of the present disclosure, the vast majority of photonic integrated circuit designs require that lightwaves within the photonic integrated circuit propagate with their electric field polarization either aligned perpendicular to the plane of the photonic integrated circuit in a “Transverse Electric” (TE) mode, or aligned parallel to the plane of the photonic integrated circuit in a “Transverse Magnetic” (TM) mode. In the illustrated examples, the laser light source 610 provides light in the TE mode, and as can be seen in FIG. 11, the first optical signal is provided from “upper right” output of directional coupler 812d in the TE mode, and the second optical signal is provided from the “lower right” output of directional coupler 812d in the TE mode.

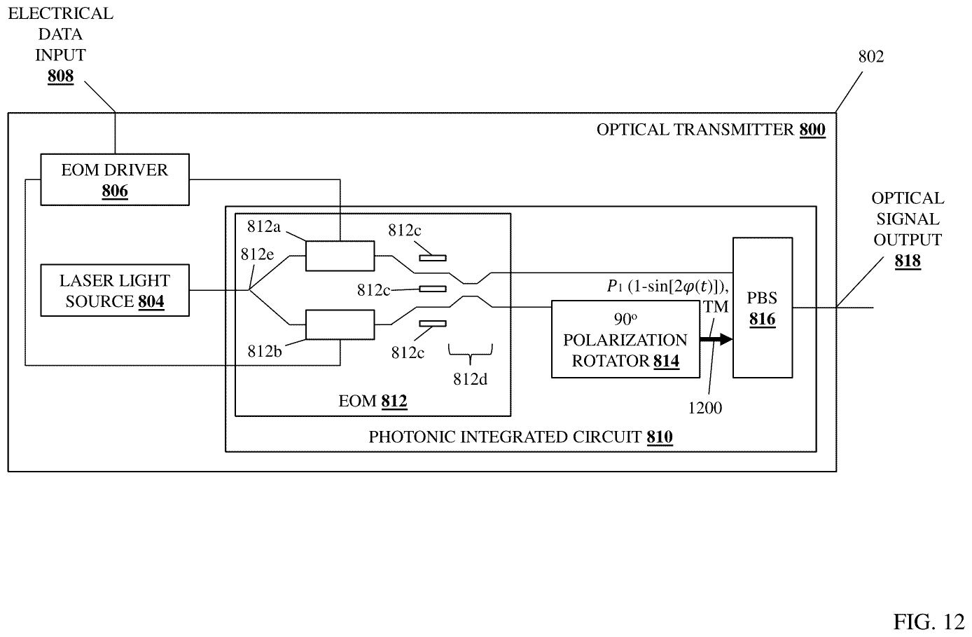

The method 1000 then proceeds to block 1004 where the optical transmitter in the first transceiver device rotates a polarization of the second optical signal to provide an orthogonally polarized second optical signal. With reference to FIG. 12, in an embodiment of block 1004, the 90° polarization rotator 814 may perform optical signal polarization rotation operations 1200 that include rotating a polarization of the second optical signal received through the optical directional coupler 812d ninety degrees to provide an orthogonally polarized second optical signal that is orthogonally polarized relative to the first optical signal that was also provided through the optical directional coupler 812d and to the PBS 608, and providing the orthogonally polarized second optical signal to the PBS 816. As can be seen in FIG. 12, the rotation of the polarization of the second optical signal by the 90° polarization rotator 814 provides the second optical signal to the PBS 816 in the TM mode discussed above.

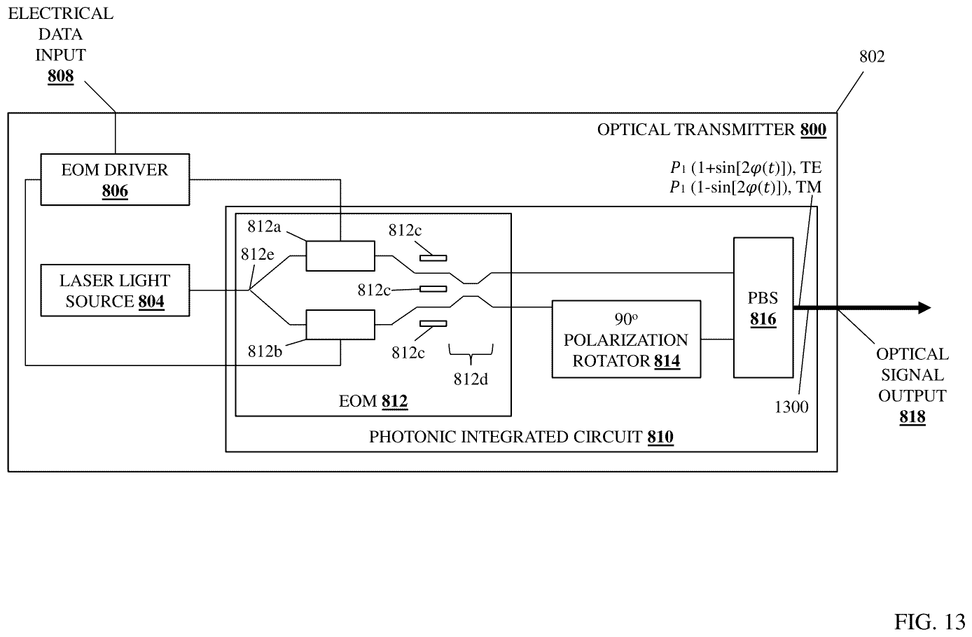

The method 1000 then proceeds to block 1006 where the optical transmitter in the first transceiver device combines the first optical signal and the orthogonally polarized second optical signal while maintaining their polarization orthogonality to provide a combined optical signal. With reference to FIG. 13, in an embodiment of block 1006, the PBS 816 may perform optical signal combination operations that include combining the first optical signal received through the optical directional coupler 812d, and the orthogonally polarized second optical signal received from the 90° polarization rotator 814, in a manner that maintains their polarization orthogonality and provides a combined optical signal.

The method 1000 then proceeds to block 1008 where the optical transmitter in the first transceiver device transmits the combined optical signal via an optical cable. With reference to FIG. 13, in an embodiment of block 1008, the PBS 816 may then perform combined optical signal transmission operations 1300 that include transmitting the combined optical signal provided at block 1006 via the optical signal output 818 and via the optical coupling 238 or 248 (e.g., a single mode optical fiber in an optical cable) discussed above with reference to FIGS. 2B and 2C. As can be seen in FIG. 12, the combination of the first optical signal and the orthogonally polarized second optical signal provides the combined optical signal that includes the first optical signal in the TE mode and the orthogonally polarized second optical signal in the TM mode at the point where the combined optical signal exits the photonic integrated circuit 810). As will be appreciated by one of skill in the art in possession of the present disclosure and as discussed in further detail below, once the combined optical signal is transmitted into standard (i.e., non-polarization-preserving or non-polarization-maintaining) single-mode optical fiber, the polarization states of first and second optical signals included in the combined optical signal will change randomly as the combined optical signal propagate through the optical fiber without changing the orthogonality of those polarization states.

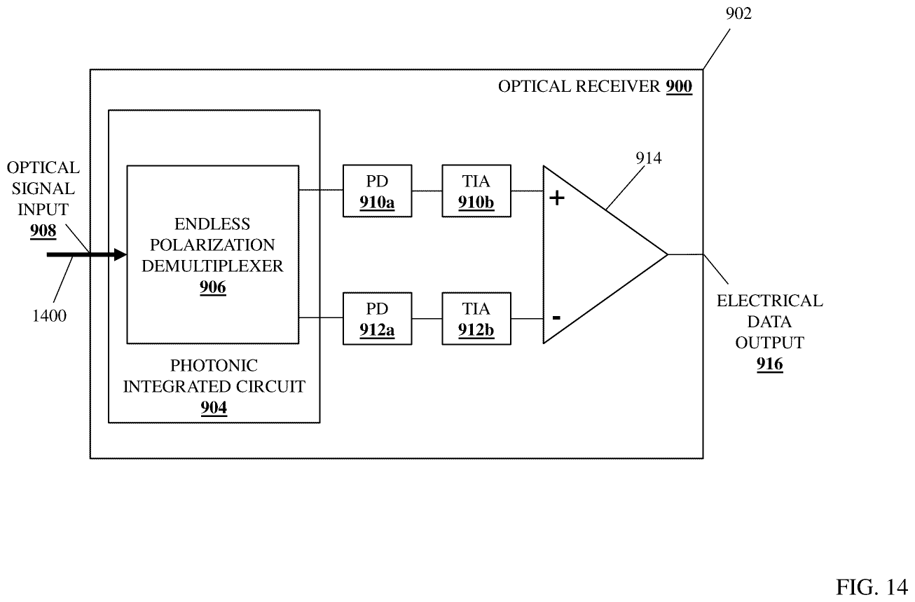

The method 1000 then proceeds to block 1010 where an optical receiver in a second transceiver device receives the combined optical signal via the optical cable. With reference to FIG. 14, in an embodiment of block 1010, the endless polarization demultiplexer 906 in the optical receiver 900 may perform combined optical signal receiving operations 1400 that include receiving the combined optical signal transmitted by the optical transmitter 800 at block 1008 via the optical coupling 238 or 248 (e.g., a single mode optical fiber in an optical cable) discussed above with reference to FIGS. 2B and 2C.

The method 1000 then proceeds to block 1012 where the optical receiver in the second transceiver device separates the first optical signal and the orthogonally polarized second signal included in the combined optical signal. In an embodiment, at block 1012, the endless polarization demultiplexer 906 in the optical receiver 900 may perform optical signal separation operations that include separating the first optical signal and the orthogonally polarized second optical signal from the combined optical signal. As discussed above, the transmission of the combined optical signal by the optical transmitter 800 at block 1008 via the optical coupling 238 or 248 (e.g., a single mode optical fiber in an optical cable) discussed above with reference to FIGS. 2B and 2C will initially provide the first optical signal and the orthogonally polarized second optical signal as linearly polarized and orthogonal to each other when the combined optical signal enters the optical coupling 238 or 248, and the first optical signal and the orthogonally polarized second optical signal will then “scramble” into unknown polarization states as they are transmitted over the optical coupling 238 or 248 (e.g., a single mode optical fiber in an optical cable) discussed above with reference to FIGS. 2B and 2C until they reach the optical receiver 900.

However, one of skill in the art in possession of the present disclosure will appreciate how the unknown polarization states of the first optical signal and the orthogonally polarized second optical signal will remain orthogonal when they reach the optical receiver 900. For example, one of skill in the art in possession of the present disclosure will recognize that, as the first and second optical signals propagate along the optical fiber, the polarization state of each optical signal will evolve along a random, but point-wise continuous, optical path on the Poincaré sphere while remaining antipodal at all times, and as states of polarization of the two optical signals are always antipodes on the Poincaré sphere, their polarizations states are always orthogonal and thus may be decomposed into two linear polarization states in the endless polarization demultiplexer 906. As such, the optical signal separation operations by the endless polarization demultiplexer 906 may operate to continuously separate the first optical signal and the orthogonally polarized second optical signal based on their orthogonal polarization states (i.e., even as the states of the first optical signal and the orthogonally polarized second optical signal change over time, and without resets that would interrupt the combined optical signal received by the optical receiver 900). In other words, the endless polarization demultiplexer 906 may operate to correct the scrambling of the polarization states of the first optical signal and the orthogonally polarized second optical signal in the combined optical signal that occurred during its transmission via the optical coupling, thus allowing the demultiplexing of the combined optical signal with the first optical signal and the orthogonally polarized second optical signal spatially separated and linearly polarized.

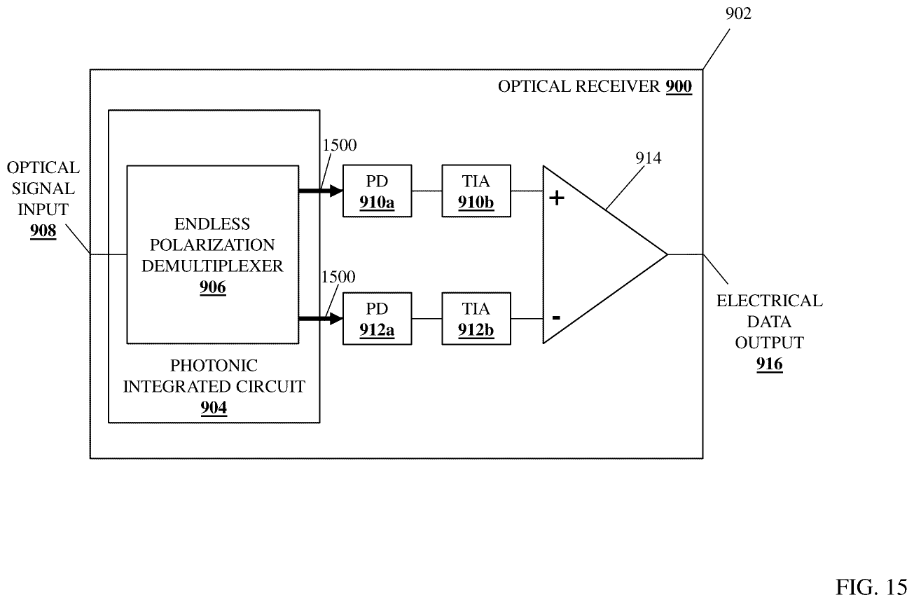

The method 1000 then proceeds to block 1014 where the optical receiver in the second transceiver device converts the first optical signal to a first electrical signal, and converts the second optical signal to a second electrical signal. With reference to FIG. 15, in an embodiment of block 1014 and subsequent to separating the first optical signal and the orthogonally polarized second optical signal included in the combined optical signal, the endless polarization demultiplexer 906 may perform signal provisioning operations 1500 that include transmitting the first optical signal to the PD 910a in the first optical/electrical conversion subsystem, and transmitting the orthogonally polarized second optical signal to the PD 912a in the second optical/electrical conversion subsystem. The PD 910a in the first optical/electrical conversion subsystem may then perform optical/electrical conversion operations that include converting the first optical signal to a first electrical signal (e.g., a photocurrent), and the PD 912a in the second optical/electrical conversion subsystem may then perform optical/electrical conversion operations that include converting the second optical signal to a second electrical signal (e.g., a photocurrent).

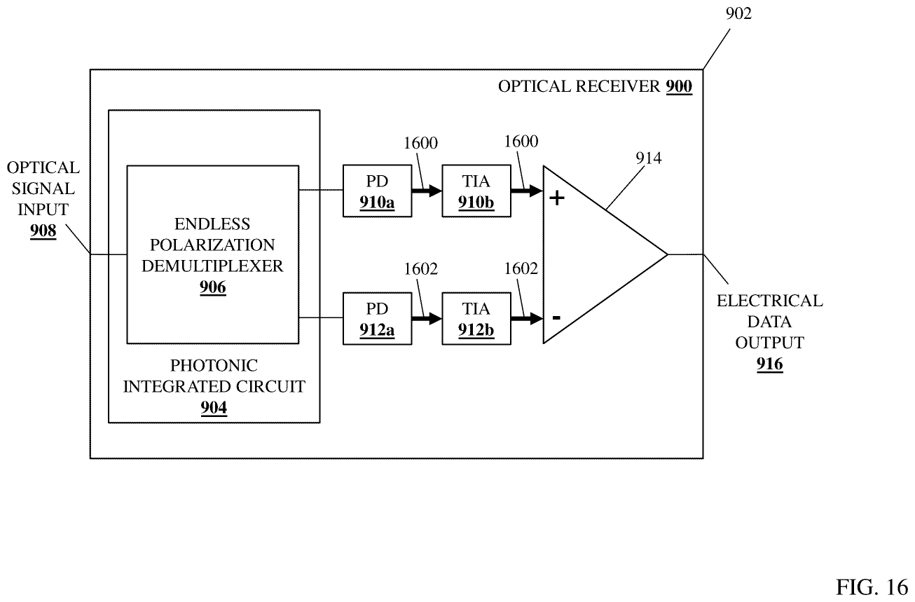

The method 1000 then proceeds to block 1016 where the optical receiver in the second transceiver device differentially combines the first electrical signal and the second electrical signal to provide a combined electrical signal. With reference to FIG. 16, in an embodiment of block 1016, the PD 910a in the first optical/electrical conversion subsystem may then perform electrical signal provisioning operations 1600 that include transmitting the first electrical signal via the TIA 910b to cause the TIA 910b to perform transimpedance amplification operations (e.g., converting the received photocurrent to a voltage) on the first electrical signal before providing the first electrical signal to the signal combination subsystem 914. Similarly, in an embodiment of block 1016, the PD 912a in the second optical/electrical conversion subsystem may then perform electrical signal provisioning operations 1602 that include transmitting the second electrical signal via the TIA 912b to cause the TIA 912b to perform transimpedance amplification operations (e.g., converting the received photocurrent to a voltage) on the second electrical signal before providing the second electrical signal to the signal combination subsystem 914.

At block 1016, the signal combination subsystem 914 may then perform signal combination operations to combine the first electrical signal and the second electrical signal to provide a combined electrical signal that is effectively the arithmetic difference between the voltages at the inputs of signal combination subsystem 914. For example, the signal combination subsystem 914 may be provided by a differential amplifier that performs the signal combination operations to essentially subtract the second electrical signal from the first electrical signal, discussed in further detail below. As will be appreciated by one of skill in the art in possession of the present disclosure and as described in detail in the discussion below, the combined electrical signal produced by the signal combination operations will have an electrical signal power that one of skill in the art in possession of the present disclosure will appreciate is four times that of the electrical signal produced by the RF amplifier 410 as part of the electrical signal provisioning operations 512 discussed above with reference to FIG. 5B (assuming the PD, TIA, and net amplifications are the same). One of skill in the art in possession of the present disclosure having read and understood the discussion on electrical noise combination below will appreciate that the uncorrelated noise associated with the combined electrical signal produced by the signal combination operations will have an electrical noise power that will be two times that of the electrical noise power produced by the RF amplifier 410 as part of the electrical signal provisioning operations 512 discussed above with reference to FIG. 5B (assuming the PD, TIA, and net amplifications are the same), which will lead to a signal to noise ratio of 3 dB.

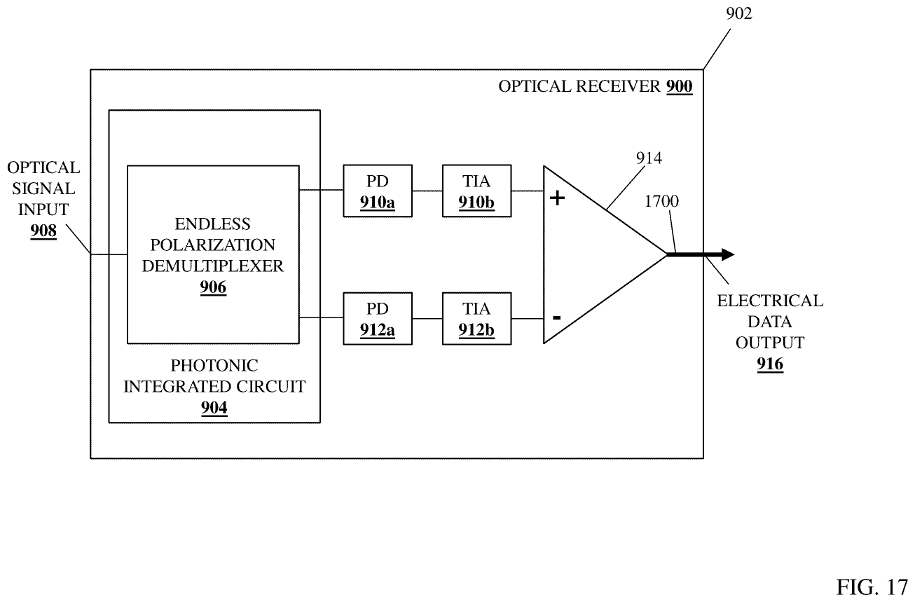

The method 1000 then proceeds to block 1018 where the optical receiver in the second transceiver device transmits the combined electrical signal. With reference to FIG. 17, in an embodiment of block 1018, the signal combination subsystem 914 may perform electrical signal transmission operations 1700 that include transmitting the differentially combined electrical signal via the electrical data output 916 such that it may be received by the DSP-based SERDES 202 or 214. As discussed above, the optical directional coupler 812d in the optical transmitter 800 provides for the recovery/recycling of the waste light 514 that is produced by the conventional optical transmitter 300 discussed above to provide the second optical signal, which as detailed below improves the effective signal-to-noise ratio of the combined electrical signal provided by the optical receiver 900 by at least 3 dB over the electrical signal provided by the conventional optical receiver 400. One of skill in the art in possession of the present disclosure will appreciate that when only uncorrelated noise sources (e.g. thermal or shot noise) are considered, those uncorrelated noise sources will combine incoherently, doubling the total noise power. However when considering common-mode RIN from the laser light source 804, noise power may subtract coherently and lead to a smaller noise increase, or even a noise reduction, upon combination.

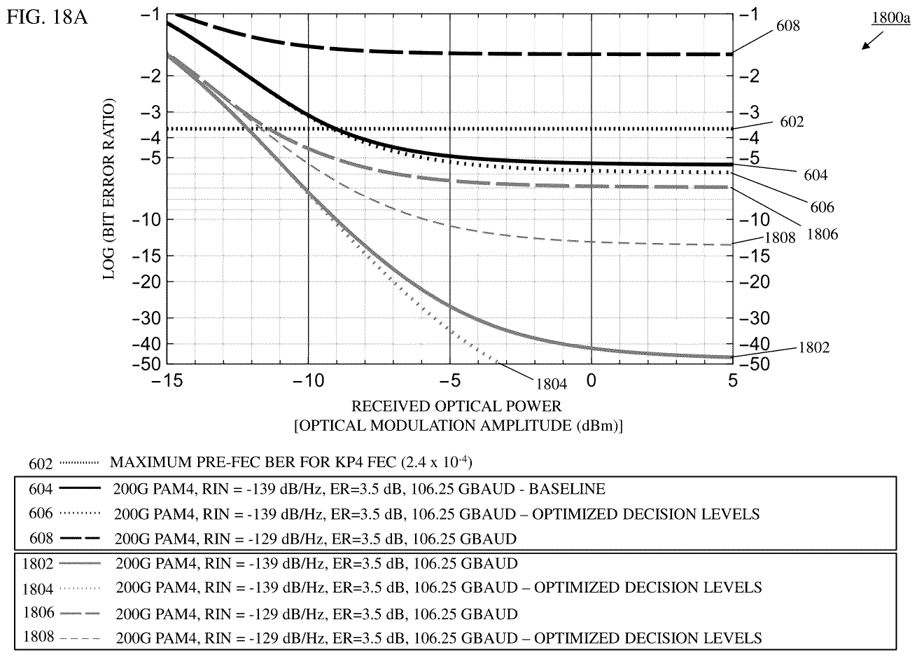

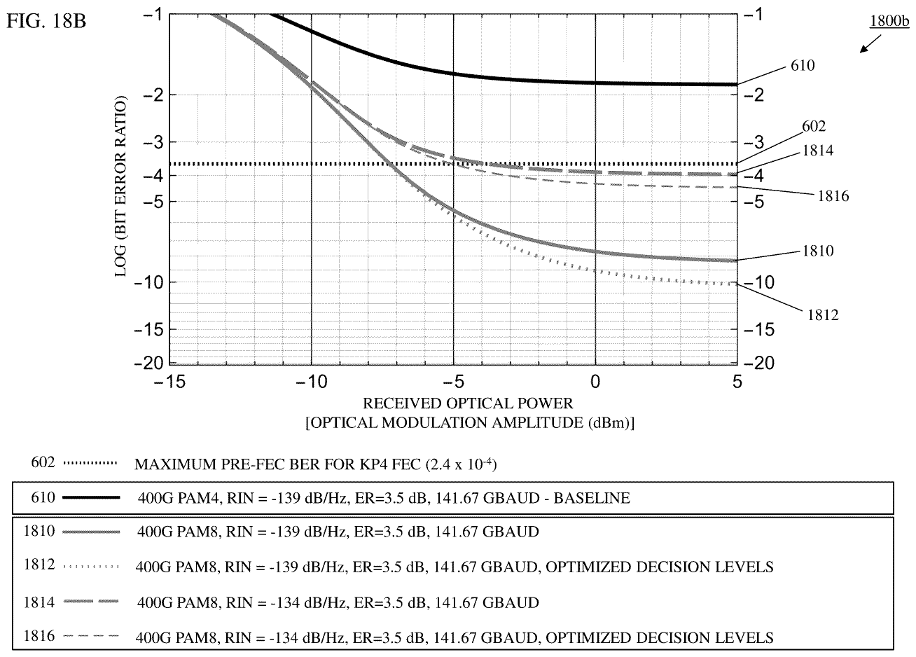

With reference to FIG. 18A, a graph 1800a is provided that plots the calculated BER against the received optical power (e.g., at the either of the PDs 910a or 912a in the optical receiver 900) for different transmission scenarios using the optical transmitter 800 and the optical receiver 900 discussed above, and that also includes the plots of the calculated BER against the received optical power for the first transmission scenario 604, the second transmission scenario 606, and the third transmission scenario 608 from the graph 600 of FIG. 6 that utilized the conventional optical transmitter 300 and the conventional optical receiver 400 at 200G using PAM4 modulation. As discussed for the graph 600, the maximum allowable pre-FEC BER limit 602 was defined as maximum allowable BER required to achieve a 10⁻¹³ post-FEC BER when using Reed Solomon (544, 514) FEC, which is also referred to as “KP4 FEC” that is used in 100 and 200 Gigabit Ethernet (GbE) single-lane optical channels in IEEE Ethernet.

In the illustrated example, a first transmission scenario 1802 was defined as 200G PAM4 symbols being transmitted with decision levels spaced equidistant between PAM4 symbol levels, a RIN of −139 dB/Hz, an ER of 3.5 dB, and a symbol rate of 106.25 Gbaud (i.e., the first transmission scenario 1802 is modeled using the same parameters as the first transmission scenario 604). A second transmission scenario 804 was defined as 200G PAM4 symbols being transmitted with decision levels optimized for the minimum BER (e.g., “OPTIMIZED DECISION LEVELS”), a RIN of −139 dB/Hz, an ER of 3.5 dB, and a symbol rate of 106.25 Gbaud (i.e., the second transmission scenario 1804 is modeled using the same parameters as the second transmission scenario 606). A third transmission scenario 1806 was defined as being transmitted as 200G PAM4 symbols with decision levels spaced equidistant between PAM4 symbol levels, a RIN of −129 dB/Hz, an extinction ratio of 3.5 dB, and a symbol rate of 106.25 Gbaud (i.e., the third transmission scenario 1806 is modeled using the same parameters as third transmission scenario 608). A fourth transmission scenario 1808 was defined as being transmitted as 200G PAM4 symbols with decision levels optimized for the minimum BER (e.g., “OPTIMIZED DECISION LEVELS”), a RIN of −129 dB/Hz, an extinction ratio of 3.5 dB, and a symbol rate of 106.25 Gbaud.

As discussed above, the use of the conventional optical transmitter 300 and the conventional optical receiver 400 in the first transmission scenario 604 results in a “noise floor” of between 105 and 106 BER, and one of skill in the art in possession of the present disclosure will appreciate that the graph 1800a illustrates how the use of the optical transmitter 800 and the optical receiver 900 in the first transmission scenario 1802 with the same parameters as the first transmission scenario 604 results in a “noise floor” of less than 10-45 BER, which one of skill in the art in possession of the present disclosure will recognize as a significant improvement over the use of the conventional optical transmitter 300 and the conventional optical receiver 400. Furthermore, the graph 1800a illustrates how the first transmission scenario 604 using the conventional optical transmitter 300 and the conventional optical receiver 400 crosses the maximum allowable pre-FEC BER limit 602 at approximately −9 dBm, while the first transmission scenario 1802 using the optical transmitter 800 and the optical receiver 900 crosses the maximum allowable pre-FEC BER limit 602 at approximately −12 dBm.

Further still, the graph 1800a illustrates how the use of the optical transmitter 800 and the optical receiver 900 to transmit optical signals via a relatively high RIN laser light source (e.g., −129 dB/Hz) improves the “noise floor” from an unviable level (e.g., a “noise floor” greater than 10⁻² BER for the third transmission scenario 608 using the conventional optical transmitter 300 and the conventional optical receiver 400) to viable levels (e.g., a “noise floor” of approximately 10⁻⁷ BER that is below the maximum allowable pre-FEC BER limit 602 for the third transmission scenario 1806). In addition, for the fourth transmission scenario 1808 with optimized decision levels, a “noise floor” of less than 10⁻¹³ BER is achieved that is well below the maximum allowable pre-FEC BER limit 602.

With reference to FIG. 18B, a graph 1800b is provided that plots the calculated BER against the received optical power (e.g., at the either PDs 910a or 912a in the optical receiver 900) for signals transmitted between the optical transmitter 800 and the optical receiver 900 discussed above, and that also includes the plots of the calculated BER against the received optical power for the fourth transmission scenario 610 using the conventional optical transmitter 300 and the conventional optical receiver 400 at 400G using PAM4 modulation. As discussed for the graph 600, the maximum allowable pre-FEC BER limit 602 was defined as the calculated maximum BER required to achieve a 10⁻¹³ BER when using Reed Solomon (544, 514) FEC, which is also referred to as “KP4 FEC” that is used in 100 and 200 Gigabit Ethernet (GbE) single-lane optical channels in IEEE Ethernet.

In the illustrated example, a fifth transmission scenario 1810 was defined as 400G PAM8 signals being transmitted with decision levels spaced equidistant between PAM4 symbol levels, a RIN of −139 dB/Hz, an ER of 3.5 dB, and a symbol rate of 141.67 Gbaud (i.e., the fifth transmission scenario 1810 is modeled with same parameters as the fourth optical signal 610). A sixth transmission scenario 1812 was defined as 400G PAM8 signals being transmitted with decision levels optimized for the minimum BER (e.g., “OPTIMIZED DECISION LEVELS”), a RIN of −139 dB/Hz, an ER of 3.5 dB, and a symbol rate of 141.67 Gbaud. A seventh transmission scenario 1814 was defined as 400G PAM8 signals being transmitted with decision levels spaced equidistant between PAM4 symbol levels, a RIN of −134 dB/Hz, an ER of 3.5 dB, and a symbol rate of 141.67 Gbaud. An eighth transmission scenario 1816 was defined as 400G PAM8 signals being transmitted with decision levels optimized for the minimum BER (e.g., “OPTIMIZED DECISION LEVELS”), a RIN of −134 dB/Hz, an ER of 3.5 dB, and a symbol rate of 141.67 Gbaud.

The graph 1800b illustrates how the use of the optical transmitter 800 and the optical receiver 900 in the fifth transmission scenario 1810 modeled with the same parameters as the fourth transmission scenario 610 improves the BER “noise floor” from an unviable level (e.g., a BER “noise floor” greater than 10⁻² BER for the fourth transmission scenario 610 using the conventional optical transmitter 300 and the conventional optical receiver 400) to viable levels (e.g., a BER “noise floor” of less than 10⁻⁸ BER for the fifth optic transmission scenario 1810 that is below the maximum allowable pre-FEC BER limit 602). Furthermore, the graph 1800b illustrates how the use of the optical transmitter 800 and the optical receiver 900 in the sixth transmission scenario 1812 with similar parameters as the fifth transmission scenario 1812 but using optimized decision levels improves the “noise floor” to less than 10⁻¹⁰ BER.

Further still, one of skill in the art in possession of the present disclosure will appreciate that the graph 1800b illustrates how the use of the optical transmitter 800 and the optical receiver 900 to transmit optical signals via a relatively high RIN laser light source (e.g., −134 dB/Hz) improves the BER “noise floor” from an unviable level (not illustrated) to viable levels (e.g., a BER “noise floor” of approximately 10⁻⁴ BER for the third transmission scenario 1814 that is below the maximum allowable pre-FEC BER limit 602, and a BER “noise floor” of less than 10⁻⁴ BER for the eighth transmission scenario 1816 with optimized decision levels that is below the maximum allowable pre-FEC BER limit 602).

Thus, the use of the optical transmitter 800 and the optical receiver 900 to transmit optical signals “moves” the BER/received optical power plots for transmission scenario “down” and “to the left” in the graphs 1800a and 1800b (i.e., relative to transmission scenario using the conventional optical transmitter 300 and the conventional optical receiver 400) and into (or further into) the region below the maximum allowable pre-FEC BER limit 602, which one of skill in the art in possession of the present disclosure will appreciate illustrates how the optical transmitter 800 and the optical receiver 900 provide for the transmission of higher quality signals than the conventional optical transmitter 300 and the conventional optical receiver 400 given the same modeling parameters (e.g., data rate, modulation format, laser RIN, extinction ratio (ER), photodetector sensitivity and efficiency, receiver thermal equivalent noise).

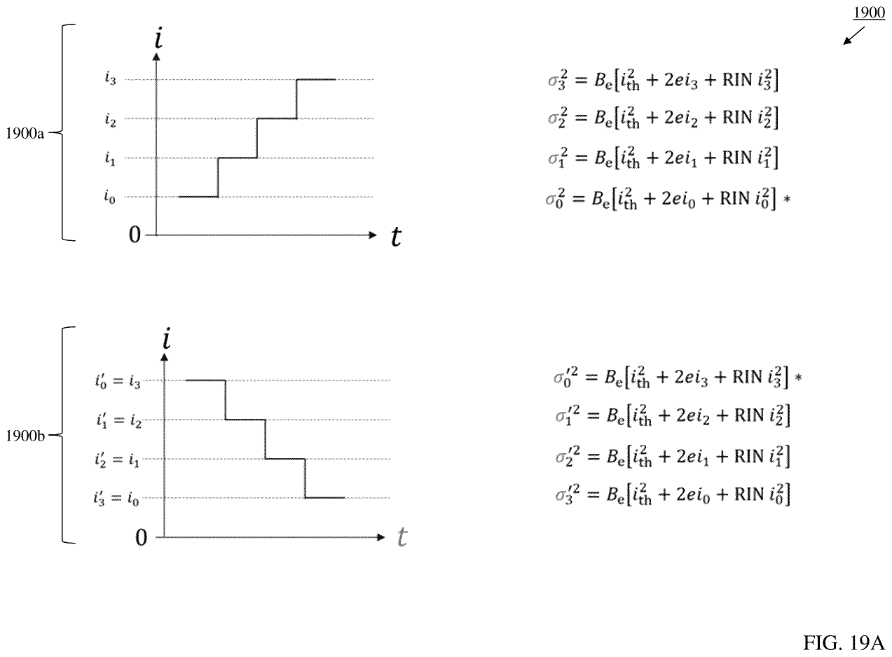

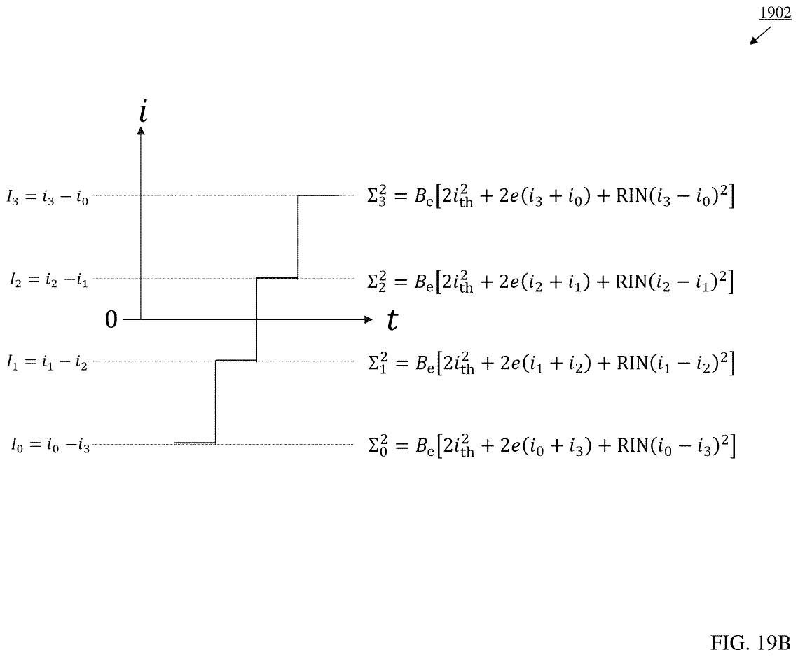

With reference to FIG. 19A, graphs 1900 are provided that include a first graph 1900a that illustrates the photocurrent level in of electrical signals generated by the PD 910a in the optical receiver 900 based on four PAM4 symbols (i.e., photocurrent levels i₀, i₁, i₂, and i₃, with the symbol levels equally spaced such that i₃−i₂=i₂−i₁=i₁−i₀=δ), and equations for photocurrent noise power σₙ² associated with each of the four PAM4 symbols (i.e., σ₀², σ₁², σ₂², and σ₃²). The graphs 1900 also include a second graph 1900b that illustrates the photocurrent level i′ₙ of electrical signals generated by the PD 912a in the optical receiver 900 based on four PAM4 symbols (i.e., photocurrent levels i′₀, i′₁, i′₂, and i′₃, with i′₀=i₃, i′₁=i₂, i′₂=i₁, and i′₃=i₀), and equations for photocurrent noise power σ′ₙ² associated with e each of the four PAM4 symbols (i.e., σ′₀², σ′₁², σ′₂², and σ′₃²). Similarly as described above, in the equations for the photocurrent noise power σₙ² and σ′ₙ², Bₑ is the electrical bandwidth of the optical receiver 900, iₜₕ is the thermal equivalent noise, e is the electron charge, iₙ is the photocurrent level of PAM4 symbol n, and RIN is the relative intensity noise of the laser light source 804 in the optical transmitter 800, with the equations generating a current noise power σₙ² and σ′ₙ² described by a normal/Gaussian probability distribution with a standard deviation σₙ and σ′ₙ, respectively. As will be appreciated by one of skill in the art in possession of the present disclosure, the iₜₕ² term in the photocurrent noise power σₙ² equation is known as the “thermal noise” term, and the 2eiₙ term in the photocurrent noise power σₙ² equation is known as the “shot noise” term. As will be appreciated by one of skill in the art in possession of the present disclosure, the photocurrent noise powers for the first PAM4 symbol “0” are each indicated by an asterisk in FIG. 19A, with the photocurrent noise power σ₀² being the smallest of all four PAM4 symbols in the first graph 1900a, and with the photocurrent noise power σ′₀² being the largest of all four PAM4 symbols in the second graph 1900b.

With reference to FIG. 19B, a graph 1902 is provided that illustrates the results of the signal combination operations by the differential amplifier discussed above that provides the signal combination subsystem 914 and that essentially subtracts the second electrical signal from the first electrical signal to provide the combined electrical signal. As will be appreciated by one of skill in the art in possession of the present disclosure, the graph 1902 illustrates the combined electrical signal resulting from the “subtraction” of the electrical signal illustrated by the first graph 1900b from the electrical signal illustrated by the second graph 1900a, with the combined electrical signal having photocurrents Iₙ and associated current noise powers Σₙ².

As can be seen in FIG. 19B, the current levels I₀, I₁, I₂, I₃ of each PAM4 symbol provided by the combined electrical signal are separated by 2δ, i.e., the overall photocurrent of the combined electrical signal (as measured between the lowest symbol and the highest symbol) transmitted using the optical transmitter 800 and the optical receiver 900 is double the overall photocurrent of the electrical signal transmitted using the conventional optical transmitter 300 and the conventional optical receiver 400. Furthermore, one of skill in the art in possession of the present disclosure will appreciate how the equations for the photocurrent noise powers Σₙ² indicate that the “thermal noise” terms iₜₕ² and the “shot noise” terms (provided by 2eiₙ as described above) generated by the PDs 910a and 912a are uncorrelated and add (or subtract) incoherently in the electrical domain. However, because the RIN detected by the PDs 910a and 912a is common to both first and second optical signals, it is completely correlated and completely in phase, and the “subtraction” operations by the differential amplifier/signal combination subsystem 914 that provide the combined electrical signal result in the coherent subtraction of RIN (i.e., as indicated by the terms RIN(i₃−i₀)², RIN(i₂−i₁)², RIN(i₁−i₂)², and RIN(i₀−i₃)² in the equations for the current noise powers Σₙ²). Thus, for the majority of symbols, the RIN contribution to overall noise is partially reduced.

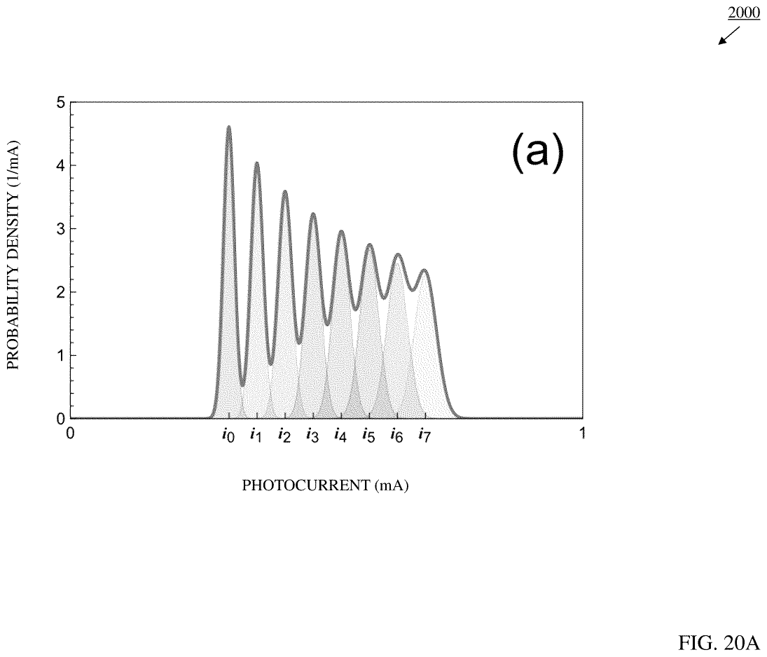

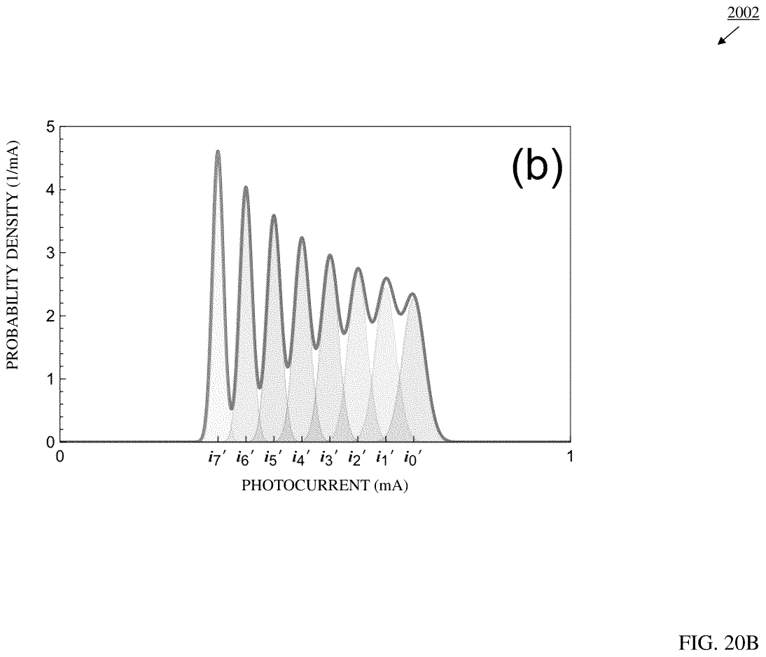

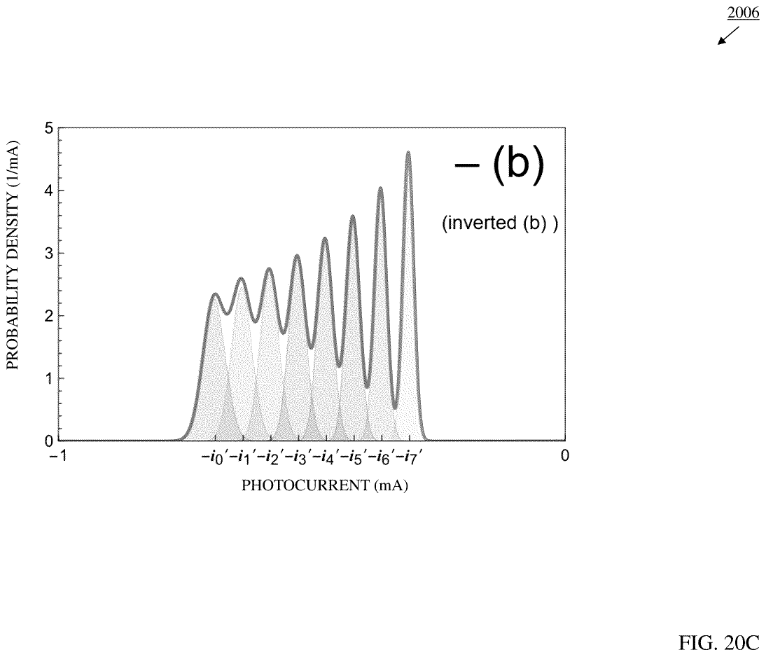

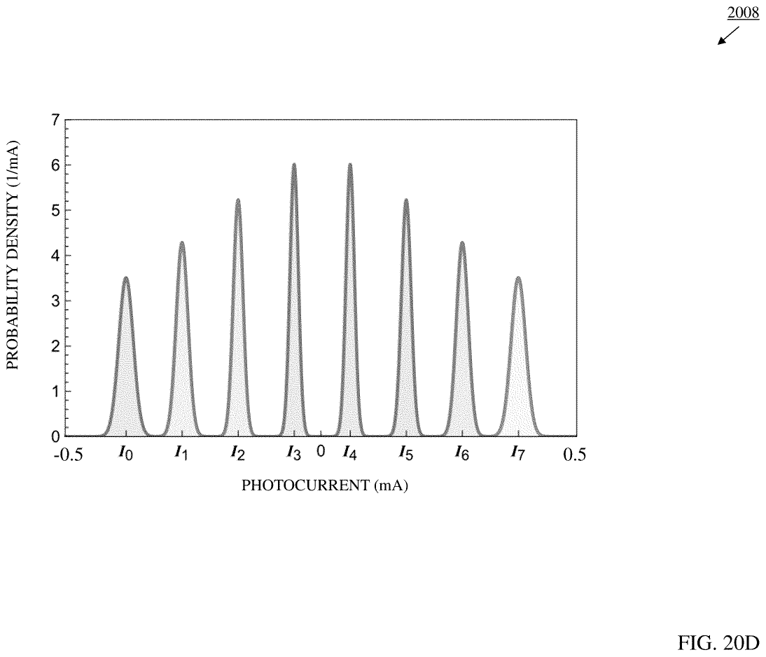

A notable exception to the RIN term partial reduction discussed above is the RIN term in the current noise power Σ₀² associated with the “0” PAM4 symbol. As discussed above, in the first graph 1900a the RIN term in the current noise power σ₀² for the “0” PAM4 symbol was the smallest RIN term for all of the PAM4 symbols and was designated by an asterisk. However, the term RIN(i₀−i₃)² in the current noise power Σ₀² is greater than the term RIN i₀² in the current noise power σ₀² (discussed in further detail below with reference to FIG. 20D), As will be appreciated by one of skill in the art in possession of the present disclosure, the systems and methods of the present disclosure operate to redistribute the distribution of current noise power among all the N PAM-N symbols in a manner that significantly reduces the BER compared to conventional IMDD transceiver systems. As discussed below, the noise associated with I₀ in FIG. 20D (which represents the noise associated with output 916) below is greater than the noise associated with i₀ in FIG. 20A (which represents the noise associated with photocurrent output from PD 910a) below, illustrating how the overall effect of net RIN-term reduction and redistribution of RIN-noise among all symbol current levels results in a significant reduction in BER compared to conventional IMDD transceiver systems.)

With reference to FIGS. 20A, 20B, 20C, and 20D, a plurality of graphs 2000, 2002, 2004, and 2006 are provided that illustrate characteristics of an optical signal transmitted with PAM8 at a data rate of 425 Gb/s and a symbol rate of 141.67 Gbaud using the optical transmitter 800 and optical receiver 900 described above. As will be appreciated by one of skill in the art in possession of the present disclosure, the graph 2000 provides the probability distributions for current measured immediately after the PD 910a in the optical receiver 900, and the graph 2002 provides the probability distributions for current measured immediately after the PD 912a in the optical receiver 900, with both graphs 2000 and 2002 illustrating how the “width” of the noise increases at higher current levels (e.g., the width of the noise increases from current levels i₀ to i₇ on the graph 2000, and the width of the noise increases from current levels i′₇ to i′₀ on the graph 2002).

Furthermore, the graph 2000 illustrates how the “7” symbol provided by the PD 910a has the highest current level (i₇) and highest noise of the symbols provided by the PD 910a, while the graph 2002 illustrates how the “7” symbol provided by the PD 912a has the lowest current level (i′₇) and lowest noise of the symbols provided by the PD 912a, as the first optical signal and the orthogonally polarized second optical signal received from the optical transmitter 800 are intensity modulated 180° out of phase with respect to each other, with their respective symbols provided in the orders illustrated and discussed with reference to FIG. 19A.

The graph 2006 illustrates the probability distributions for current measured immediately after the PD 912a in the optical receiver 900 with the symbols and noise inverted (i.e., the graph 2006 is an inversion of the graph 2004), and one of skill in the art in possession of the present disclosure will appreciate how the differential amplifier that provides the signal conversion subsystem 914 may effectively perform such an inversion, and add that inverted current to the (non-inverted) current from 910a in order to perform the signal combination operations (e.g., the signal “subtraction”) discussed above. As will be appreciated by one of skill in the art in possession of the present disclosure, the signal combination operations by the differential amplifier/signal combination subsystem 914 discussed above may include adding the graphs 2002 and 2006 in order to essentially subtract the second electrical signal from the first electrical signal to provide the combined electrical signal as described above, and the graph 2008 illustrates the results, with the levels Iₙ being determined as discussed above with reference to FIG. 19B, and the current noise power Σₙ² at each symbol level Iₙ calculated as discussed above with reference to FIG. 19B As will be appreciated by one of skill in the art in possession of the present disclosure, the graph 2008 illustrate how the signal combination operations by the differential amplifier/signal combination subsystem 914 operates to increase the spacing between the current levels I₀-I₇ from δ to 2δ. Furthermore, one of skill in the art in possession of the present disclosure will appreciate how the RIN calculated for each symbol is proportional to the square of the difference between the current levels for that symbol after each PD 910a and 912a (i.e., as indicated by the terms RIN(i₃−i₀)², RIN(i₂−i₁)², RIN(i₁−i₂)², and RIN(i₀−i₃)² in the equations for the current noise powers Σₙ²), as can be seen in the equations for the current noise powers Σₙ² in FIG. 19B.

Thus, FIG. 20D illustrates how the use of the optical transmitter 800 and the optical receiver 900 provide greater current level spacing and reduced RIN contributions to noise that result in sharper and higher definition probability distributions for the currents that are used to provide the combined electrical signal. For example, the use of the optical transmitter 800 and optical receiver 900 discussed above to transmit an optical signal with PAM8 modulation at the data rate of 425 Gbaud and a symbol rate of 141.67 Gbaud in order to achieve a received optical power of −3 dBm will result in a BER of 1×10⁻⁷, while the use of the conventional optical transmitter 300 and the conventional optical receiver 400 discussed above to transmit the same optical signal (i.e., with PAM8 modulation at the data rate of 425 Gbaud and a symbol rate of 141.67 Gbaud in order to achieve the received optical power of −3 dBm) will result in a generally unacceptable BER of 8×10⁻¹.

As will be appreciated by one of skill in the art in possession of the present disclosure, probabilistic shaping of the PAM-N constellation may be used to increase the overall effectiveness of the networked system 200 via manipulation of signal coding. Furthermore, in thermal-noise-limited systems where the noise for each PAM-N level is relatively similar, some techniques for probabilistic shaping may be optimal, while in RIN-noise limited systems the noise at each PAM-N symbol level increases monotonically with increasing photocurrent, other techniques for probabilistic shaping may be optimal. As will be appreciated by one of skill in the art in possession of the present disclosure, the distribution of noise across the PAM-N symbol levels that is provided by the systems and methods described herein is different than either the thermal-noise-limited or RIN-noise-limited systems described above (i.e., the noise distribution provided by the systems and methods described herein is minimized near the center of the PAM4 constellation and maximum at the extrema of the PAM4 constellation, as illustrated in plot 2008), and will required the application of probabilistic shaping principals to the novel noise profiles provided by the systems and methods.

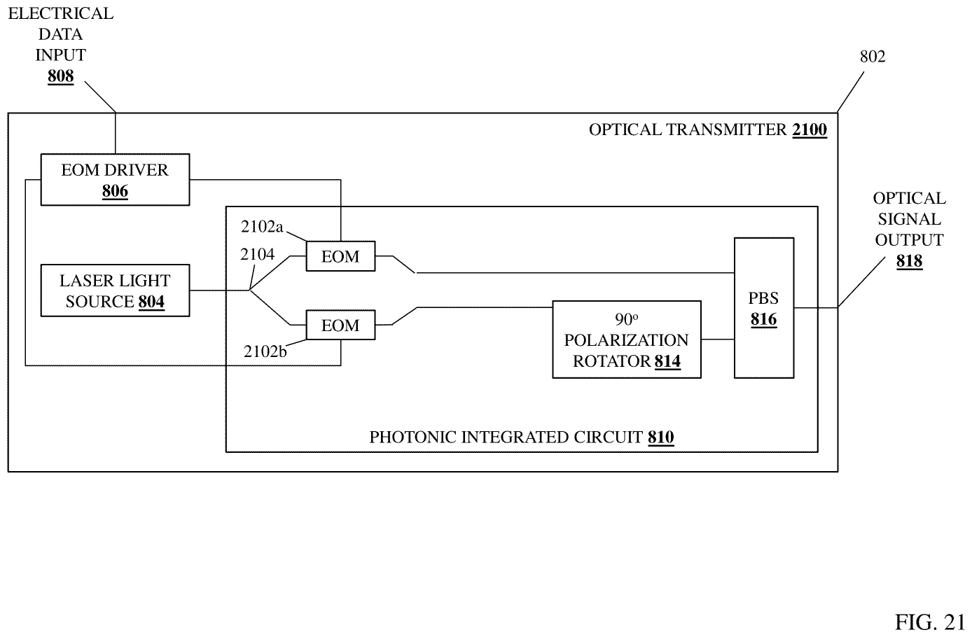

However, while several specific examples of the IMDD optical transceiver system of the present disclosure have been described, one of skill in the art in possession of the present disclosure will appreciate how a variety of modifications to the systems and methods described above with fall within the scope of the present disclosure. For example, FIG. 21 illustrates an optical transmitter 2100 that is similar to the optical transmitter 800 discussed above (with the same elements having the same element numbers), and that may be used with the optical receiver 900 discussed above. However, the optical transmitter 2100 replaces the EOM 812 in the optical transmitter 800 with a pair of EOMs 2102a and 2102b that may be provided by MZIs, electro-absorptive modulators, and/or other “generic” EOMs that would be apparent to one of skill in the art in possession of the present disclosure. The EOMs 2102a and 2102b are optically coupled to the laser light source 804 via an input Y-junction 2104, and are each electrically coupled to the EOM driver 806. Further, the EOM 2102a is optically coupled to the PBS 816, and the EOM 2102b is optically coupled to the 90° polarization rotator 814.

Similarly as described above for the phase modulators 812a and 812b, the EOM driver 806 may provide out-of-phase electrical signals V_{SIGNAL} and V̅_{SIGNAL} to the EOMs 2102a and 2102b, respectively, to cause the EOM 2102a to use the light provided by the laser light source 804 to provide a first optical signal with a power P₁ (1+sin [χ(t)]) to the PBS 816, and to cause the EOM 2102b to use the light provided by the laser light source 804 to provide a second optical signal with a power P₁ (1−sin [χ(t)]) to the 90° polarization rotator 814. Similarly as discussed above, the light may be provided from the laser light source 804 in the TE mode, the EOMs 2102a and 2102b may provide the first optical signal and second optical signal, respectively, to the PBS 816 and the 90° polarization rotator 814, respectively, in the TE mode, with the 90° polarization rotator 814 then rotating the polarization of the second optical signal to the TM mode discussed above before providing the resulting orthogonally polarized second optical signal to the PBS 816. As will be appreciated by one of skill in the art in possession of the present disclosure, the optical transmitter 2100 does not recover waste light like the optical transmitter 800 discussed above, but provides the benefits of the partial RIN cancellation discussed above when used with the optical receiver 900.

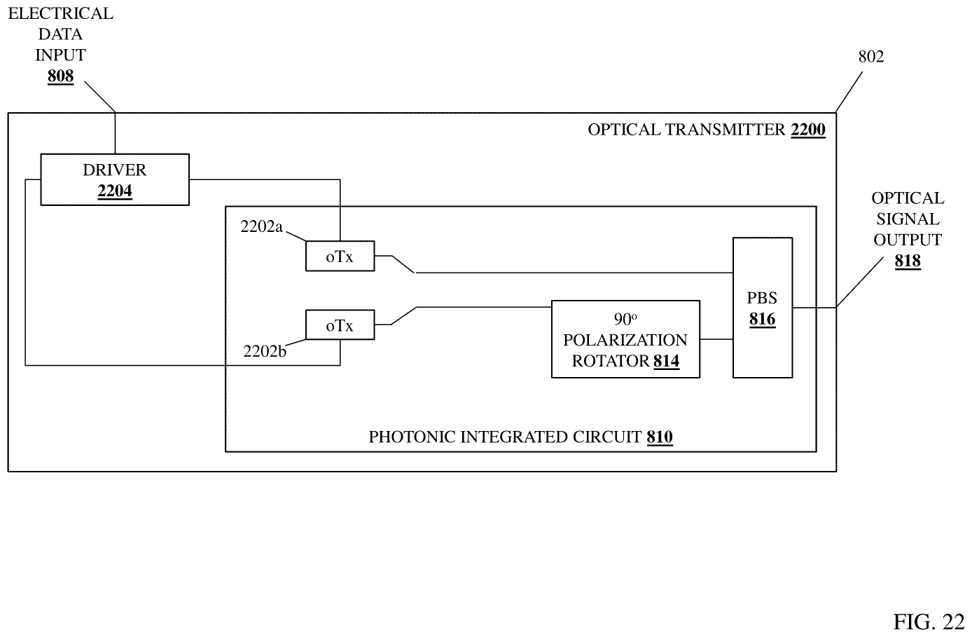

In another example, FIG. 22 illustrates an optical transmitter 2200 that is similar to the optical transmitter 800 discussed above (with the same elements having the same element numbers), and that may be used with the optical receiver 900 discussed above. However, the optical transmitter 2200 replaces the laser light source 804 and the EOM 812 in the optical transmitter 800 with a pair of optical transceivers (oTxs) 2202a and 2202b that may be provided by respective directly modulated laser devices, respective externally modulated laser devices, and/or other “generic” optical transceivers that one of skill in the art in possession of the present disclosure would recognize as providing different distinct light sources. The optical transceivers 2202a and 2202b are each electrically coupled to a driver 2204, with the optical transceiver 2202a optically coupled to the PBS 816, and the optical transceiver 2202b optically coupled to the 90° polarization rotator 814.

Similarly as described above for the phase modulators 812a and 812b, the driver 2204 may provide out-of-phase electrical signals V_{SIGNAL} and V̅_{SIGNAL} (or currents) to the optical transceivers 2202a and 2202b, respectively, to cause the optical transceiver 2202a to provide a first optical signal with a power P₁ (1+sin [χ(t)]) to the PBS 816, and to cause the optical transceiver 2202b to provide a second optical signal with a power P₁ (1−sin [χ(t)]) to the 90° polarization rotator 814. Similarly as discussed above, the optical transceivers 2202a and 2202b may provide the first optical signal and second optical signal, respectively, to the PBS 816 and the 90° polarization rotator 814, respectively, in the TE mode, with the 90° polarization rotator 814 then rotating the polarization of the second optical signal to the TM mode discussed above before providing the resulting orthogonally polarized second optical signal to the PBS 816. As will be appreciated by one of skill in the art in possession of the present disclosure, the optical transmitter 2200 does not recover waste light like the optical transmitter 800 discussed above, and does not provide the benefits of the partial RIN cancellation discussed above when used with the optical receiver 900, but will produce the effective signal-to-noise ratio improvement of 3 dB when the uncorrelated RIN terms from the first and second optical signals are subtracted incoherently in the differential amplifier in the optical receiver 900.

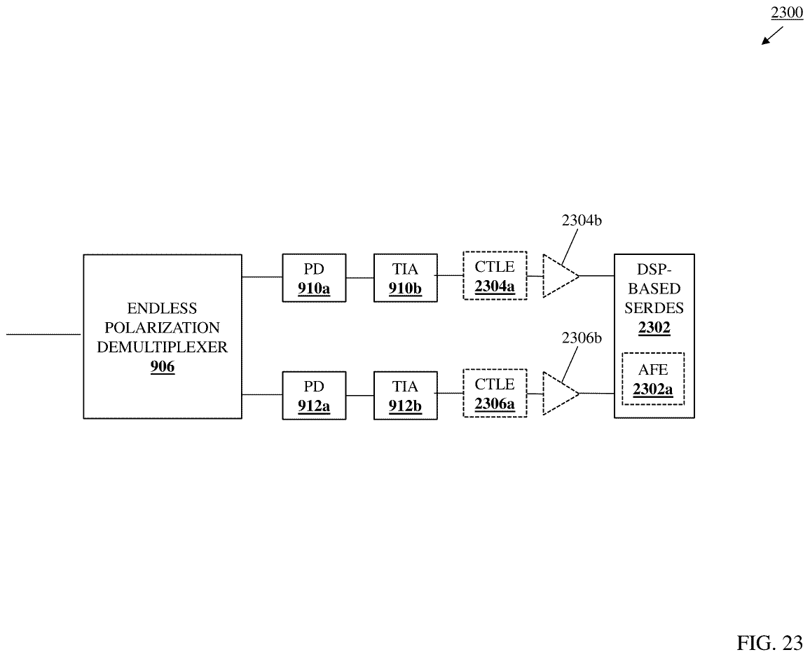

In yet another example, FIG. 23 illustrates an optical receiver system 2300 that uses the endless polarization multiplexer 906, the first optical/electrical conversion subsystem (i.e., the PD 910a and TIA 910b), and the second optical/electrical conversion subsystem (i.e., the PD 912a and TIA 912b) of the optical receiver 900 discussed above (with the same elements having the same element numbers), and that may be used with the optical transmitter 800 discussed above. The optical receiver system 2300 is coupled to a DSP-based SERDES 2302 having an optional AFE 2302a that is similar to the DSP-based SERDES 202 and 214 discussed above with reference to FIGS. 2A-2C, with the DSP-based SERDES 2302 replacing the signal conversion subsystem 914 (e.g., the differential amplifier discussed above) in the optical receiver 900 and receiving the first electrical signal and the orthogonally polarized second electrical signal from the TIAs 910b and 912b in the first optical/electrical conversion subsystem and the second optical/electrical conversion subsystem, respectively. Similarly to the DSP-based SERDES 202 and 214, the DSP-based SERDES 2302 may be incorporated into a processing system that is similar to processing systems 240 or 244 and that may apply additional digital signal processing in some embodiments.

As such, the DSP-based SERDES 2302 will differ from the DSP-based SERDES 202 and 214 discussed above with reference to FIGS. 2A-2C by having a pair of SERDES receivers, with a first SERDES receiver receiving the first electrical signal from the TIA 910b in the first optical/electrical conversion subsystem, and a second SERDES receiver receiving the second electrical signal from the TIA 912b in the second optical/electrical conversion subsystem. As such, the DSP-based SERDES 2302 may be re-architected (i.e., relative to the DSP-based SERDES 202 and 214) to include two SERDES receivers (and one SERDES transmitter) for each link, as well as to perform the signal conversion functionality (i.e. to invert the second electrical signal received from the TIA 912b in the second optical/electrical conversion subsystem, combine the inverted second electrical signal with the first electrical signal, etc.) that is described above as being performed by the signal conversion subsystem 914 (e.g., the differential amplifier discussed above).

Furthermore, one of skill in the art in possession of the present disclosure will appreciate how the DSP-based SERDES 2302 may be configured to perform path length accounting functionality that accounts for the differences in the first electrical/optical signal path and the second electrical/optical signal path provided by the optical transmitter 800 and the receiver system 2300 (similarly as described above for the first and second electrical/optical signal paths provided by the optical transmitter 800 and the optical receiver 900), which one of skill in the art in possession of the present disclosure will appreciate allows software in the DSP-based SERDES 2302 to account for the differences in the first electrical/optical signal path and the second electrical/optical signal path, rather than requiring the relatively tight electrical/optical signal path tolerances to be accounted for using the photonic integrated circuits described above.

FIG. 23 also illustrates how CTLEs and RF amplifiers (e.g., the CTLE 2304a and RF amplifier 2304b coupling the TIA 910b to the DSP-based SERDES 2302, and the CTLE 2306a and RF amplifier 2306b coupling the TIA 912b to the DSP-based SERDES 2302) may be used with the optional AFE 2302a in the DSP-based SERDES 2302, which one of skill in the art in possession of the present disclosure will appreciate allows the receiver system 2300 to be used in the DSP-based retimed transceiver systems and the direct-drive un-retimed linear transceiver systems discussed above, with the “on-board”, “near-packaged”, or “co-packaged” transceiver devices (e.g., Linear Pluggable Optical (LPO) transceiver devices, on-board optical or near-package transceiver devices, and Co-Packaged Optical (CPO) transceiver devices discussed above), and with the electrical/optical communication conversion aggregator system like that described in U.S. patent application Ser. No. 19/027,109, attorney docket no. 140389.01, filed on Jan. 17, 2025, discussed above.

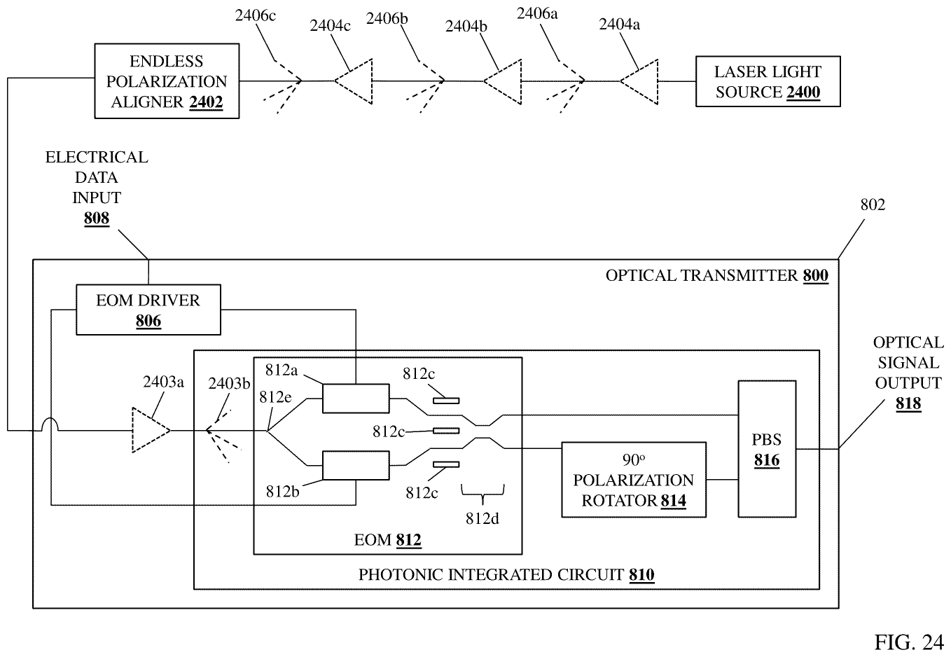

In yet another example, FIG. 24 illustrates the optical transmitter 800 that is coupled to a laser light source 2400 via an endless polarization aligner 2402 that is coupled to the input Y-junction 812e provided in the EOM 812 by the photonic integrated circuit 810, and that may be used with the optical receiver 900 discussed above. In the illustrated examples, the endless polarization aligner 2402 is coupled to the input Y-junction 812e by an optional polarization preserving optical amplifier 2403a (as indicated by the dashed lines in FIG. 24) that is included in the optical transmitter 800, and an optional polarization-preserving optical splitter 2403b (as indicated by the dashed lines in FIG. 24) that is provided by the photonic integrated circuit 810. While the endless polarization aligner 2402 is external to the photonic integrated circuit 810 in the illustrated embodiment, one of skill in the art in possession of the present disclosure will appreciate how the endless polarization aligner 2402 may be internal to/part of the photonic integrated circuit 810 while remaining within the scope of the present disclosure as well. As will be appreciated by one of skill in the art in possession of the present disclosure, the endless polarization aligner 2402 may be provided when non-polarization-preserving optical fibers are used as the optical coupling between the laser light source 2400 and the photonic integrated circuit 810 and, similar to the endless polarization demultiplexer 906 in the optical receiver 900 discussed above, the endless polarization aligner 2402 may operate to actively linearly polarize scrambled polarized light received from the laser light source 2400 to provide that light to the input Y-junction 812e in the TE mode discussed above.

The illustrated example includes a plurality of optional standard/non-polarization-preserving optical amplifiers 2404a, 2404b, and 2404c (as indicated by the dashed lines in FIG. 24) and a plurality of optional standard/non-polarization-preserving optical splitters 2406a, 2406b, and 2406c (as indicated by the dashed lines in FIG. 24) coupling the laser light source 2400 to the endless polarization aligner 2402 (with the optional optical splitter 2406a located between the optional optical amplifiers 2404a and 2404b, the optional optical splitter 2406b located between the optional optical amplifiers 2404b and 2404c, and the optional optical splitter 2406c located between the optional optical amplifier 2404c and the endless polarization aligner 2402). While the optical amplifiers 2404a, 2404b, and 2404c are external to the photonic integrated circuit 810 in the illustrated embodiment, one of skill in the art in possession of the present disclosure will appreciate how the optical amplifiers 2404a, 2404b, and 2404c may be internal to/part of the photonic integrated circuit 810 while remaining within the scope of the present disclosure as well. As will be appreciated by one of skill in the art in possession of the present disclosure, the endless polarization aligner 2402 operates to convert scrambled (but polarized) light received from the laser light source 2400 via the optical amplifiers 2404a-2404c and the optical splitters 2406a-2406c into linearly polarized light that it transmits to the optical transmitter, with the optical fiber cable, waveguides, the optical amplifier 2403a, and the optical splitter 2403b maintaining that linear polarization while providing that light to the input Y-junction 812e.

One of skill in the art in possession of the present disclosure will also appreciate that polarization preserving optical 2403b may also be used in embodiments where the optical transmitter 800 is fed by a single laser light source 804 rather than the endless polarization aligner 2402, thus allowing the single laser light source 804 to feed multiple parallel EOMs 812 in parallel on the same photonic integrated circuit 810.

As will be appreciated by one of skill in the art in possession of the present disclosure, in addition to the RIN provided by the laser light source 2400, each of the optical amplifiers 2403a, 2404a, 2404b, and 2404c adds an effective RIN provided by the equation:

$${RIN}_{OA} = \frac{2 hv}{{P}_{in}} ( NF - 1 / G )$$

with hv provided by the energy of a single photon at the operation wavelength λ of the optical laser source (ν=c/λ), Pᵢₙ provided by the input power to the optical amplifier, NF provided by a Noise Figure for the optical amplifier, and G provided by the gain of the optical amplifier.

Furthermore, one of skill in the art in possession of the present disclosure will appreciate how the optional optical splitters 2403b, 2406a, 2406b, and 2406c (e.g., 1×N optical splitters) may split the light output from the laser light source 2400 that has been optically amplified to allow a single laser light source to operate as the light source for a plurality of photonic-integrated-circuit-based EOMs used in optical transceiver devices in a datacenter (or a portion of a datacenter). Similarly, optical amplifiers may enable a single laser light source to output light to multiple EOMs on a single photonic integrated circuit.

As such, the total RIN at the PDs 910a and 912a in the optical receiver 900 may be provided by the equation:

$${RIN}_{total} = {RIN}_{laser} + {RIN}_{OA 1} + {RIN}_{OA 2} + {RIN}_{OA 3} + …$$

With RINₗₐₛₑᵣ provided by the RIN of the laser light source 2400, RIN_{OA1} provided by the RIN of the optical amplifier 2402a, RIN_{OA2} provided by the RIN of the optical amplifier 2402b, RIN_{OA3} provided by the RIN of the optical amplifier 2402c, and any additional optical amplifiers (e.g., the optical amplifier 2403a) providing corresponding RIN similarly to the optical amplifiers 2402a-2402c.

As will be appreciated by one of skill in the art in possession of the present disclosure, the RIN originating after the input Y-junction 812e is common mode noise that will be fully correlated at the PDs 910a and 912a in the optical receiver 900, while RIN originating after the PBS 816 (e.g., from optical amplifiers) will be fully uncorrelated at the PDs 910a and 912a in the optical receiver 900 due to that RIN being produced from “beating” between the signal electrical field and the electrical field of the spontaneous emission of the optical amplifier. As will be appreciated by one of skill in the art in possession of the present disclosure, the spontaneous emission is parallel to each of the orthogonal signal electric field vectors and uncorrelated, and thus the RIN from the optical amplifier after the PBS 816 will be uncorrelated at the PDs 910a and 912a in the optical receiver 900. As such, the RIN at the PDs 910a and 912a in the optical receiver 900 will be made up of two components: correlated RIN_{COR} and uncorrelated RIN_{UNC}, and the total RIN equation above may be rewritten as:

$${RIN}_{total} = {RIN}_{COR} + {RIN}_{UNC}$$

As will be appreciated by one of skill in the art in possession of the present disclosure, the optical receiver 900 will operate to subtract the uncorrelated RIN_{UNC} coherently between the PDs 910a and 912a while the correlated RIN_{COR} will sum coherently, and the noise photocurrent power may be calculated (e.g., for a PAM4 signal) by the equations provided below:

$${\sum }_{3}^{2} = {B}_{e} [ 2 {i}_{th}^{2} + 2 e ( {i}_{3} + {i}_{0} ) + {RIN}_{unc} ( {i}_{3}^{2} + {i}_{0}^{2} ) + {{RIN}_{cor} ( {i}_{3} - {i}_{0} )}^{2} ]$$

$${\sum }_{2}^{2} = {B}_{e} [ 2 {i}_{th}^{2} + 2 e ( {i}_{2} + {i}_{1} ) + {RIN}_{unc} ( {i}_{2}^{2} + {i}_{1}^{2} ) + {{RIN}_{cor} ( {i}_{2} - {i}_{1} )}^{2} ]$$

$${\sum }_{1}^{2} = {B}_{e} [ 2 {i}_{th}^{2} + 2 e ( {i}_{1} + {i}_{2} ) + {RIN}_{unc} ( {i}_{1}^{2} + {i}_{2}^{2} ) + {{RIN}_{cor} ( {i}_{1} - {i}_{2} )}^{2} ]$$

$${\sum }_{0}^{2} = {B}_{e} [ 2 {i}_{th}^{2} + 2 e ( {i}_{0} + {i}_{3} ) + {RIN}_{unc} ( {i}_{0}^{2} + {i}_{3}^{2} ) + {{RIN}_{cor} ( {i}_{0} - {i}_{3} )}^{2} ]$$

Thus, systems and methods have been described that include an optical transmitter that rotates a polarization of one of a pair of optical signals that are output from its Mach Zehnder Interferometer before combining them into a combined optical signal that it transmits to an optical receiver, with the optical receiver separating the optical signals, converting them to respective electrical signals, and combining the electrical signals into a combined electrical signal. For example, the IMDD optical transceiver system of the present disclosure may include first and second transceiver devices connected to an optical cable. The first transceiver device modulates light to generate first and second optical signals having the same data and respective 180-degree out-of-phase intensities, rotates a polarization of the second optical signal to provide an orthogonally polarized second optical signal, and combines the first and orthogonally polarized second optical signal while maintaining their relative polarization orthogonality to provide a combined optical signal that it transmits via the optical cable. The first optical receiver receives the combined optical signal via the optical cable, separates the first and orthogonally polarized second optical signal in the first combined optical signal, converts the first and orthogonally polarized second optical signal to first and second electrical signals, respectively, and combines them to provide a combined electrical signal, and transmits the combined electrical signal. As described above, the IMDD optical transceiver system of the present disclosure enables the transmission of optical signals using of higher order modulation, higher speeds, and lower symbol rates relative to conventional IMDD optical transceiver systems.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Intensity Modulated Direct Detection (IMDD) optical transceiver system, comprising:
an optical cable;
a first optical transceiver device that is connected to the optical cable and that is configured to:
modulate light to generate a first optical signal and a second optical signal that include the same data and that include respective intensities that are 180 degrees out of phase;
rotate a polarization of the second optical signal to provide an orthogonally polarized second optical signal that is orthogonally polarized relative to the first optical signal;
combine the first optical signal and the orthogonally polarized second optical signal while maintaining a polarization orthogonality of the first optical signal and the orthogonally polarized second optical signal to provide a combined optical signal; and
transmit the combined optical signal via the optical cable; and
a second optical transceiver device that is connected to the optical cable and that is configured to:
receive the combined optical signal via the optical cable;
separate the first optical signal and the orthogonally polarized second optical signal that are included in the combined optical signal;
convert the first optical signal to a first electrical signal;
convert the orthogonally polarized second optical signal to a second electrical signal;
combine the first electrical signal and the second electrical signal to provide a combined electrical signal; and
transmit the combined electrical signal.

2. The IMDD optical transceiver system of claim 1, wherein the first optical transceiver device is configured to combine the first electrical signal and the second electrical signal to provide the combined electrical signal using a differential amplifier, a Digital Signal Processor, or an integrated circuit.

3. The IMDD optical transceiver system of claim 1, wherein the first optical transceiver device and the second optical transceiver device provide a first electrical/optical signal path and a second electrical/optical signal path, and wherein the first electrical/optical signal path and the second electrical/optical signal path are configured such that a first time period required to traverse the first electrical/optical signal path and a second time period required to traverse the second electrical/optical signal path do not differ by more than a threshold amount of time.

4. The IMDD optical transceiver system of claim 2, wherein a portion of the first electrical/optical signal path and the second electrical/optical signal path included in the first optical transceiver device is provided by a first photonic integrated circuit, and wherein a second portion of the first electrical/optical signal path and the second electrical/optical signal path included in the second optical transceiver device is provided by a second photonic integrated circuit.

5. The IMDD optical transceiver system of claim 1, wherein the first optical transceiver device includes:
a laser light source that is configured to generate the light.

6. The IMDD optical transceiver system of claim 1, wherein further comprising:
a laser light source that is configured to generate the light; and
at least one optical amplifier that couples the laser light source to the first optical transceiver device and that is configured to receive the light from the laser light source and provide the light to the first optical transceiver device.

7. An Intensity Modulated Direct Detection (IMDD) transceiver device, comprising:
an optical transmitter including:
an Electro-Optical Modulator (EOM) that includes an optical directional coupler and that is configured to modulate light to generate a first optical signal and a second optical signal that include the same data and that include respective intensities that are 180 degrees out of phase;
a polarization rotator that is coupled to the EOM and that is configured to receive the second optical signal and rotate a polarization of the second optical signal to provide an orthogonally polarized second optical signal that is orthogonally polarized relative to the first optical signal; and
a polarization beam splitter that is coupled to the EOM and the polarization rotator and that is configured to receive the first optical signal and the orthogonally polarized second optical signal, combine the first optical signal and the orthogonally polarized second optical signal while maintaining a polarization orthogonality of the first optical signal and the orthogonally polarized second optical signal to provide a first combined optical signal, and transmit the first combined optical signal via an optical cable.

8. The IMDD transceiver device of claim 7, further comprising:
an optical receiver including:
a polarization demultiplexer that is configured to receive a second combined optical signal via the optical cable and separate a third optical signal and fourth optical signal that are included in the second combined optical signal;
a first optical/electrical conversion subsystem that is coupled to the polarization demultiplexer and that is configured to receive the third optical signal and convert the third optical signal to a third electrical signal;
a second optical/electrical conversion subsystem that is coupled to the polarization demultiplexer and that is configured to receive the fourth optical signal and convert the fourth optical signal to a fourth electrical signal; and
a signal combination subsystem that is coupled to the first optical/electrical conversion subsystem and the second optical/electrical conversion subsystem and that is configured to receive the third electrical signal and the fourth electrical signal, combine the third electrical signal and the fourth electrical signal via subtraction to provide a combined electrical signal, and transmit the combined electrical signal.

9. The IMDD transceiver device of claim 8, wherein the signal combination subsystem is provided by a differential amplifier, a Digital Signal Processor, or an integrated circuit.

10. The IMDD transceiver device of claim 8, wherein the optical transmitter and the optical receiver provide a first electrical/optical signal path and a second electrical/optical signal path, and wherein the first electrical/optical signal path and the second electrical/optical signal path are configured such that a first time period required to traverse the first electrical/optical signal path and a second time period required to traverse the second electrical/optical signal path do not differ by more than a threshold amount of time.

11. The IMDD transceiver device of claim 10, wherein the first electrical/optical signal path and the second electrical/optical signal path are provided by a photonic integrated circuit.

12. The IMDD transceiver device of claim 7, further comprising:
a laser light source that is configured to generate the light and provide the light to the EOM.

13. The IMDD transceiver device of claim 7, wherein the optical transmitter is configured to be coupled to a laser light source via at least one optical amplifier and receive the light generated by the laser light source via the at least one optical amplifier.

14. A method for transmitting data in an Intensity Modulated Direct Detection (IMDD) optical transceiver system, comprising:
modulating, by an optical transmitter in an Intensity Modulated Direct Detection (IMDD) transceiver device, light to generate a first optical signal and a second optical signal that include the same data and that include respective intensities that are 180 degrees out of phase;
rotating, by the optical transmitter in the IMDD transceiver device, a polarization of the second optical signal to provide an orthogonally polarized second optical signal that is orthogonally polarized to the first optical signal;
combining, by the optical transmitter in the IMDD transceiver device, the first optical signal and the orthogonally polarized second optical signal while maintaining a polarization orthogonality of the first optical signal and the orthogonally polarized second optical signal to provide a first combined optical signal; and
transmitting, by the optical transmitter in the IMDD transceiver device, the first combined optical signal via an optical cable.

15. The method of claim 14, further comprising:
receiving, by an optical receiver in the IMDD transceiver device, a second combined optical signal via the optical cable;
separating, by the optical receiver in the IMDD transceiver device, a third optical signal and a fourth optical signal that are included in the second combined optical signal;
converting, by the optical receiver in the IMDD transceiver device, the third optical signal to a third electrical signal;
converting, by the optical receiver in the IMDD transceiver device, the fourth optical signal to a fourth electrical signal;
combining, by the optical receiver in the IMDD transceiver device, the third electrical signal and the fourth electrical signal to provide a combined electrical signal; and
transmitting, by the optical receiver in the IMDD transceiver device, the combined electrical signal.

16. The method of claim 15, wherein the combining the first electrical signal and the second electrical signal to provide the combined electrical signal is performed by the optical receiver in the IMDD transceiver device using a differential amplifier, a Digital Signal Processor, or an integrated circuit.

17. The method of claim 15, wherein the optical transmitter and the optical receiver provide a first electrical/optical signal path and a second electrical/optical signal path, and wherein the first electrical/optical signal path and the second electrical/optical signal path are configured such that a first time period required to traverse the first electrical/optical signal path and a second time period required to traverse the second electrical/optical signal path do not differ by more than a threshold amount of time.

18. The method of claim 17, wherein the first electrical/optical signal path and the second electrical/optical signal path are provided by a photonic integrated circuit.

19. The method of claim 14, further comprising:
generating, by a laser light source in the IMDD transceiver device, the light.

20. The method of claim 14, further comprising:
receiving, by the optical transmitter in the IMDD transceiver device, the light generated by a laser light source that is coupled to the IMDD transceiver device via at least one optical amplifier.
